(19) United States
(12) Patent Application Publication
(10) Pub. No.: US 2005/0234892 A1
(43) Pub. Date: Oct. 20, 2005

(54) Information-processing system, information-processing apparatus, information-recording method, recording medium and computer program

(75) Inventor: Yosuke Tamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/090,127

(22) Filed: Mar. 28, 2005

(30) Foreign Application Priority Data
Apr. 15, 2004 (JP) 2004-120716

(51) Int. Cl. G06F 17/30

(52) U.S. Cl. 707/3

(57) ABSTRACT

The present invention provides an information-processing system for providing information from a first information-processing apparatus to a second information-processing apparatus by way of a network, wherein: the first information-processing apparatus includes: a reception section for receiving a request from the second information-processing apparatus as a request for information to be provided by the first information-processing apparatus; and a transmission section for transmitting a file of the information to be provided by the first information-processing apparatus in processing units each decodable independently of the others of the processing units to the second information-processing apparatus; and the second information-processing apparatus includes: an information-holding section for holding the information transmitted by the first information-processing apparatus; an information-requesting section for managing the information held by the information-holding section and, in dependence of the amount of the information held by the information-holding section, issuing a request to the first information-processing apparatus as a request for transmission of the following information composing one of the processing units; and a reproduction section for reproducing the information in aforementioned processing units when the amount of the information held by the information-holding section becomes greater than a reference value set in advance before all the processing units of the file are received.

### BACKGROUND OF THE INVENTION

The present invention relates to an information-processing system, an information-processing apparatus, an information-processing method, a recording medium and a computer program. More specifically, the present invention relates to an information-processing system capable of continuously receiving a stream of the same distributed content even if an information-processing apparatus employed in the system moves as well as relates to the information-processing apparatus, an information-processing method adopted in the information-processing system, a computer program implementing the information-processing method and a recording medium used for storing the computer program.

In recent years, the Internet has been becoming popular and a variety of contents are transmitted from a server to a client by way of the Internet. A content can be provided to a client in a push or pull implementation. In addition, a content is provided to a client as a file or a stream. In general, if a content is provided to a client as a file, an HTTP (Hyper Text Transfer Protocol) is adopted. In the case of streaming transmission, on the other hand, an RTP (Real-Time Protocol) (disclosed in “RTP: A transport Protocol for Real-Time Applications” authored by H. Schulzrinne, S. Casner, R. Frederick, and V. Jacobson, RFC 1889, January 1996) is utilized.

If a content is provided to a client as a file, the client receives all data of the file and is capable of reproducing the data after storing the data. Thus, if the size of the file is big, a period of time between the start of the reception of the file and its reproduction is relatively long.

In the case of streaming transmission, on the other hand, the client is capable of reproducing the content in the range of a content portion already received. Thus, the content can be reproduced in a real-time manner.

In addition, in the push implementation, the server manages the state in which a content is provided from the server to the client. In the pull implementation, on the other hand, the client manages the state in which a content is provided from the server to the client. In this case, the server transmits the content to a client at a request made by the client.

If a content is transmitted to a client by streaming transmission in the push implementation, typically, a procedure like one shown in FIG. 1 is followed. In this procedure, first of all, control is executed to establish connection between a server 11 and a client 12. Then, the server 11 transmits data of content to the client 12 as a stream. Subsequently, the server 11 receives feedback information on the streaming transmission and manages connection information. If the connection information indicates that the content is not received by the client 12 for some reasons, the server 11 retransmits the content to the client 12.

If a content is transmitted to a client 12 by streaming transmission in the push implementation, however, the server 11 generally executes management as to how far the content has been transmitted to the client. Thus, the streaming transmission of content in the push implementation raises a problem of a big load to be borne by the server 11. In addition, if the client 12 moves to any other location, it may be difficult for the client 12 to continue the streaming reception of the content from the server 11 in some cases. In such cases, it is necessary for the client 12 to continue the streaming reception of the content from another server. In order for the client 12 to continue the streaming reception of the content from another server, however, it is necessary to make a transition of management of the content transmission state from the previous server 11 to the other server. In many cases, nevertheless, it is practically difficult to make such a transition of management of the content transmission state. As a result, the related-art information-processing system raises a problem that a movement of the client 12 to any other location makes it difficult to receive a content transmitted by the servers in the streaming transmission.

### SUMMARY OF THE INVENTION

It is thus an object of the present invention addressing the situation described above to allow a client to continue receiving a content transmitted by a server in the streaming transmission even if the client moves to any other location.

According to a first aspect of the present invention, there is provided an information-processing system for providing information from a first information-processing apparatus to a second information-processing apparatus by way of a network, wherein:
the first information-processing apparatus comprises:
   a reception section for receiving a request from the second information-processing apparatus as a request for information to be provided by the first information-processing apparatus; and
   a transmission section for transmitting a file of the information to be provided by the first information-processing apparatus in processing units each decodable independently of the others of the processing units to the second information-processing apparatus; and
the second information-processing apparatus comprises:
   an information-holding section for holding the information transmitted by the first information-processing apparatus;
   an information-requesting section for managing the information held by the information-holding section and, in dependence of the amount of the information held by the information-holding section, issuing a request to the first information-processing apparatus as a request for transmission of the following information composing one of the processing units; and
   a reproduction section for reproducing the information in aforementioned processing units when the amount of the information held by the information-holding section becomes greater than a reference value set in advance before all the processing units of the file are received.

Preferably, the transmission section divides each of the processing units into transmission units, in which each of the processing units is transmitted from the first information-processing apparatus to the second information-processing apparatus. The second information-processing apparatus may further comprise a temporary storage section for temporarily storing information transmitted by the first information-processing apparatus in transmission units and, when the number of transmission units stored in the temporary storage section reaches the number of transmission units composing a processing unit, the transmission units stored in the temporary storage section may be transferred to the information-holding unit to be held therein.

Preferably, the processing unit and the transmission unit are handled as a process unit and a segment respectively.

Preferably, the segment is set to have such a size that the segment can be accommodated in a packet used as a unit of transmission by way of the network.

According to a second aspect of the present invention, there is provided an information-processing method adopted by an information-processing system for providing information from a first information-processing apparatus to a second information-processing apparatus by way of a network, the information-processing method comprising a first information-processing method adopted by the first information-processing apparatus and a second information-processing method adopted by the second information-processing apparatus;
the first information-processing method comprising the steps of:
   receiving a request from the second information-processing apparatus as a request for information to be provided by the first information-processing apparatus; and
   transmitting a file of the information to be provided by the first information-processing apparatus in processing units each decodable independently of the others of the processing units to the second information-processing apparatus;
the second information-processing method comprising the steps of:
   holding the information transmitted by the first information-processing apparatus;
   managing the information held in processing carried out at the information-holding step and, in dependence of the amount of the information held in processing carried out at the information-holding step, issuing a request to the first information-processing apparatus as a request for transmission of the following information composing one of the processing units; and
   reproducing the information in aforementioned processing units when the amount of the information held in processing carried out at the information-holding step becomes greater than a reference value set in advance before all the processing units of the file are received.

According to a third aspect of the present invention, there is provided an information-processing apparatus for receiving a request for information from an other information-processing apparatus by way of a network and transmitting the requested information to the other information-processing apparatus in accordance with the request by way of the network, the information-processing apparatus comprising:
a reception section for receiving a request from the other information-processing apparatus as a request for each of processing units each decodable independently of the others of the processing units to be transmitted to the other information-processing apparatus as one of the processing units composing a file of the requested information;
a transmission section for dividing each of the processing units into transmission units and transmitting the information in aforementioned transmission units to the other information-processing apparatus; and
a determination section for:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting the transmission section to transmit a next one of the processing units in aforementioned transmission units if the reception section receives a request for the next processing unit.

Preferably, the processing unit and the transmission unit are handled as a process unit and a segment respectively.

Preferably, the segment is set to have such a size that the segment can be accommodated in a packet used as a unit of transmission by way of the network.

Preferably, the transmission section transmits an empty segment virtually containing no information with a timing coinciding with the beginning of each of the processing units.

According to a fourth aspect of the present invention, there is provided an information-processing method adopted by an information-processing apparatus for receiving a request for information from an other information-processing apparatus by way of a network and transmitting the requested information to the other information-processing apparatus in accordance with the request by way of the network, the information-processing method comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting to transmit a next one of the processing units in aforementioned transmission units in processing carried out at the above unit-dividing and unit-transmitting step if a request for the next processing unit is received in processing carried out at the above request-receiving step.

According to a fifth aspect of the present invention, there is provided a recording medium for storing a computer program of an information-processing apparatus for receiving a request for information from an other information-processing apparatus by way of a network and transmitting the information to the other information-processing apparatus in accordance with the request by way of the network, the computer program comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting to transmit a next one of the processing units in aforementioned transmission units in processing carried out at the above unit-dividing and unit-transmitting step if a request for the next processing unit is received in processing carried out at the above request-receiving step.

According to a sixth aspect of the present invention, there is provided a computer program of an information-processing apparatus for receiving a request for information from an other information-processing apparatus by way of a network and transmitting the information to the other information-processing apparatus in accordance with the request by way of the network, the computer program comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting to transmit a next one of the processing units in aforementioned transmission units in processing carried out at the above unit-dividing and unit-transmitting step if a request for the next processing unit is received in processing carried out at the above request-receiving step.

According to a seventh aspect of the present invention, there is provided an information-processing apparatus for requesting an other information-processing apparatus to provide information to the information-processing apparatus by way of a network and receiving the information from the other information-processing apparatus, the information-processing apparatus comprising:
an information-holding section for holding the requested information transmitted by the other information-processing apparatus by dividing a file of the information into processing units each decodable independently of the others of the processing units, further dividing each of the processing units into transmission units and transmitting each of the transmission units by way of the network;
a determination section for determining the amount of information held by the information-holding section as one of the processing units;
a unit-requesting section for requesting the other information-processing apparatus to provide a next one of the processing units to the information-processing apparatus on the basis of a determination result produced by the determination section;
a request management section for managing requests issued to the other information-processing apparatus; and
a reproduction section for reproducing the information in aforementioned processing units when the amount of the information held by the information-holding section becomes greater than a reference value set in advance before all the processing units of the file are received.

Preferably, the management section is capable of managing information identifying other information-processing apparatus, times at which the other information-processing apparatus is requested to transmit any one of the processing units and planned amounts of information to be held in the information-holding section.

Preferably, the unit-requesting section notifies the other information-processing apparatus of a planned amount of information to be held in the information-holding section and the information-processing apparatus further comprises an updating section for updating a reserved magnitude of an amount of information to be held in the information-holding section on the basis of the planned amount of information reported to the other information-processing apparatus.

Preferably, the processing unit and the transmission unit are handled as a process unit and a segment respectively.

Preferably, the segment is set to have such a size that the segment can be accommodated in a packet used as a unit of transmission by way of the network.

Preferably, the information-processing apparatus further comprises a period-processing section for computing a period of time between issuance of a request for a processing unit to the other information-processing apparatus and reception of the requested processing unit when an empty segment virtually containing no information is received with a timing coinciding with the beginning of each of the processing units.

Preferably, the information-processing apparatus further comprises:
a temporary storage section for temporarily storing transmission units transmitted by the other information-processing apparatus till all transmission units of one processing unit are received from the other information-processing apparatus; and
a transfer unit section for transferring the transmission units stored in the temporary storage section to the information-holding section to be held therein as all transmission units of one processing unit are stored in the temporary storage section.

According to an eighth aspect of the present invention, there is provided an information-processing method adopted in an information-processing apparatus for requesting an other information-processing apparatus to provide information to the information-processing apparatus by way of a network and receiving the information from the other information-processing apparatus, the information-processing method comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.

According to a ninth aspect of the present invention, there is provided a recording medium for storing a computer program of an information-processing apparatus for requesting an other information-processing apparatus to provide information to the information-processing apparatus by way of a network and receiving the information from the other information-processing apparatus, the computer program comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.

According to a tenth aspect of the present invention, there is provided a computer program of an information-processing apparatus for requesting an other information-processing apparatus to provide information to the information-processing apparatus by way of a network and receiving the information from the other information-processing apparatus, the computer program comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.

In accordance with the information-processing system according to the present invention and an information-processing method adopted in the information-processing system, the first information-processing apparatus divides a file into processing units each decodable independently of the others of the processing units and transmits the processing units to the second information-processing apparatus. On the other and, the second information-processing apparatus holds the information received from the first information-processing apparatus, manages the held information and requests the first information-processing apparatus to transmit next information in dependence on the amount of the held information. As the amount of the held information exceeds a reference value, the second information-processing apparatus reproduces the held information in aforementioned processing units.

In accordance with an information-processing apparatus according to the present invention, an information-processing method adopted by the information-processing apparatus, a computer program for implementing the information-processing method and a recording medium for storing the computer program, when a request for one of processing units resulting from division of a file as processing units each decodable independently of the others of the processing units is received from another information-processing apparatus, information of the requested processing unit is transmitted to the other information-processing apparatus in transmission units, which are obtained as a result of dividing the requested processing unit. When all transmission units of one processing unit is transmitted, transmission of the processing unit is terminated.

In accordance with another information-processing apparatus according to the present invention, an information-processing method adopted by the other information-processing apparatus, a computer program for implementing the information-processing method and a recording medium for storing the computer program, information of processing units transmitted by dividing each of the processing units into transmission units is stored in aforementioned processing units. On the basis of the amount of information of a stored processing unit, transmission of a next processing unit is requested. When the amount of the stored information exceeds a reference value set in advance, the information is reproduced in processing units.

In accordance with the present invention, information can be transmitted from a first information-processing apparatus to a second information-processing apparatus by streaming transmission. In particular, even if the second information-processing apparatus moves to any other location, information can still be transmitted to the second information-processing apparatus by streaming transmission in a pull implementation with a high degree of reliability.

In addition, in accordance with the present invention, an information-processing apparatus is capable of transmitting information to another information-processing apparatus by streaming transmission. In particular, even if the other information-processing apparatus moves to any other location, information can still be transmitted to the other information-processing apparatus by streaming transmission with ease and a high degree of reliability.

On the top of that, in accordance with the present invention, an information-processing apparatus is capable of receiving information from another information-processing apparatus transmitting the information by streaming transmission. In particular, even if the information-processing apparatus moves to any other location, the information processing apparatus is still capable of receiving a continuation of information received prior to the movement in streaming transmission without a big load.

### BRIEF DESCRIPTION OF THE DRAWINGS

FIG. 1 is an explanatory diagram showing a related-art information-processing system of a push implementation;

FIG. 2 is an explanatory diagram showing an information-processing system adopting a pull implementation according to the present invention;

FIG. 3 is an explanatory diagram showing movements of a client;

FIG. 4 is an explanatory diagram showing movements of a client;

FIG. 5 is a block diagram showing a typical configuration of an information-processing system according to the present invention;

FIG. 6 is a block diagram showing a typical configuration of a server employed in the information-processing system shown in FIG. 5;

FIG. 7 is an explanatory diagram showing mapping information;

FIG. 8 is an explanatory diagram showing a GOP (Group Of Pictures);

FIG. 9 is an explanatory diagram showing a typical configuration of the GOP;

FIG. 10 is a block diagram showing a typical configuration of a client employed in the information-processing system shown in FIG. 5;

FIG. 11 is an explanatory diagram showing a delay buffer;

FIG. 12 is an explanatory diagram showing status information;

FIG. 13 is an explanatory diagram showing information described in the header of a packet;

FIG. 14 is a block diagram showing a typical configuration of sections operating in a client in a transmission of data to a server;

FIG. 15 shows a flowchart representing transmission timer processing carried out by a client;

FIG. 16 shows a flowchart representing processing carried out by a client to transmit a packet used as a request for a process unit to a server;

FIG. 17 is a block diagram showing a typical configuration of sections operating in a server;

FIG. 18 shows a flowchart representing processing carried out by a server to receive a packet used as a request for a process unit from a client;

FIG. 19 is an explanatory diagram referred to in describing computation of a roundtrip time;

FIG. 20 is a block diagram showing a typical configuration of sections operating in a client in a reception of data from a server;

FIG. 21 shows a flowchart representing processing carried out by a client to receive a segment from a server;

FIG. 22 is a block diagram showing a typical configuration of sections operating in a client in reproduction of process units;

FIG. 23 shows a flowchart representing processing carried out by a client to reproduce process units;

FIG. 24 shows a flowchart representing processing carried out by a client to qualify a server;

FIG. 25 shows a flowchart representing processing carried out by a client to select a server;

FIG. 26 is a diagram showing a result of simulation;

FIG. 27 is a diagram showing another result of simulation; and

FIG. 28 is a diagram showing a further result of simulation.

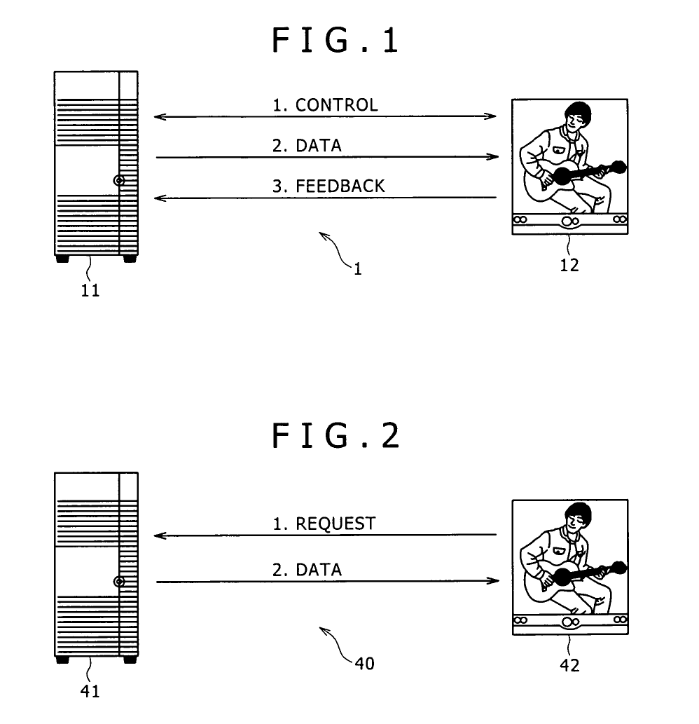

### DETAILED DESCRIPTION OF THE PREFERRED EMBODIMENTS

Before preferred embodiments of the present invention are explained, relations between disclosed inventions and the embodiments are explained in the following comparative description. It is to be noted that, even if there is an embodiment described in this specification but not included in the following comparative description as an embodiment corresponding to an invention, such an embodiment is not to be interpreted as an embodiment not corresponding to an invention. Conversely, an embodiment included in the following comparative description as an embodiment corresponding to a specific invention is not to be interpreted as an embodiment not corresponding to an invention other than the specific invention.

In addition, the following comparative description is not to be interpreted as a comprehensive description covering all inventions disclosed in this specification. In other words, the following comparative description by no means denies existence of inventions disclosed in this specification but not included in claims as inventions for which a patent application is filed. That is to say, the following comparative description by no means denies existence of inventions to be included in a separate application for a patent, included in an amendment to this specification or added in the future.

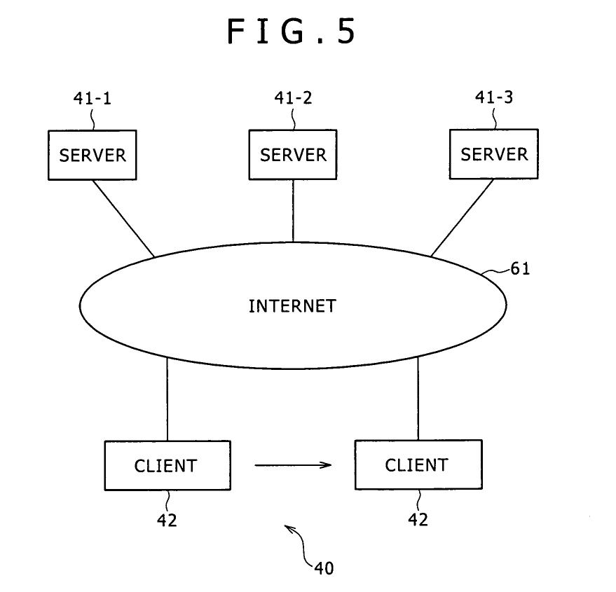

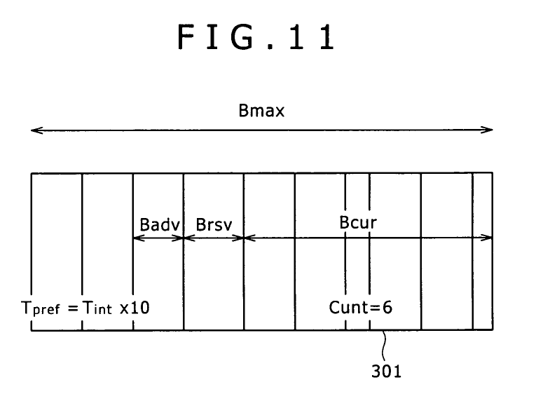

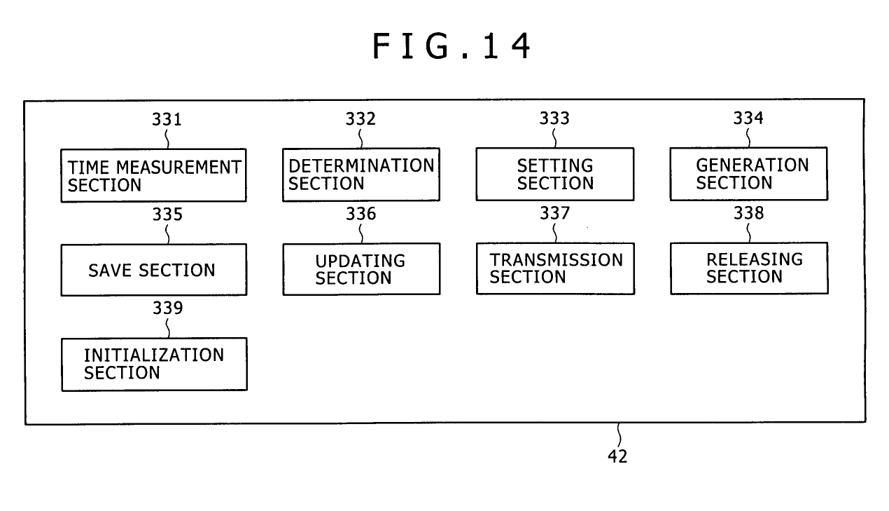

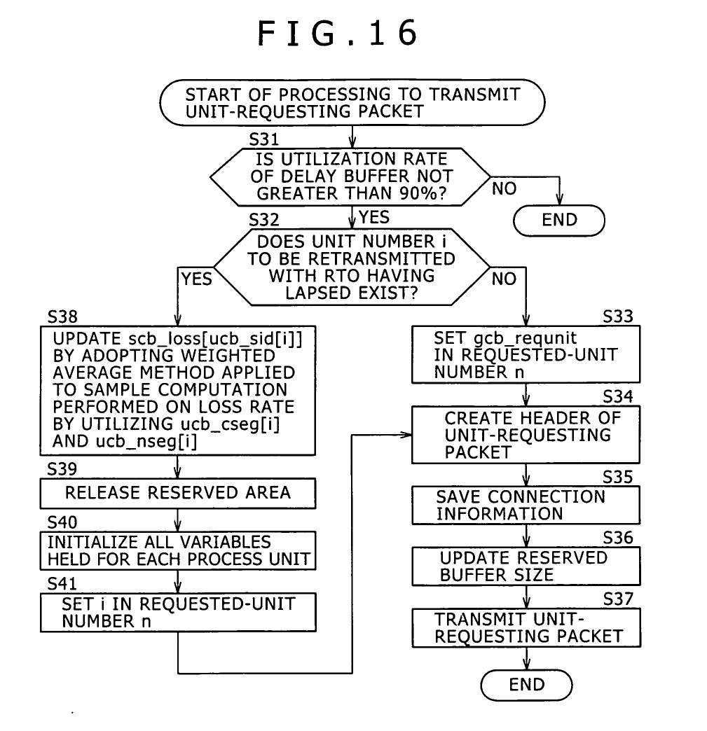

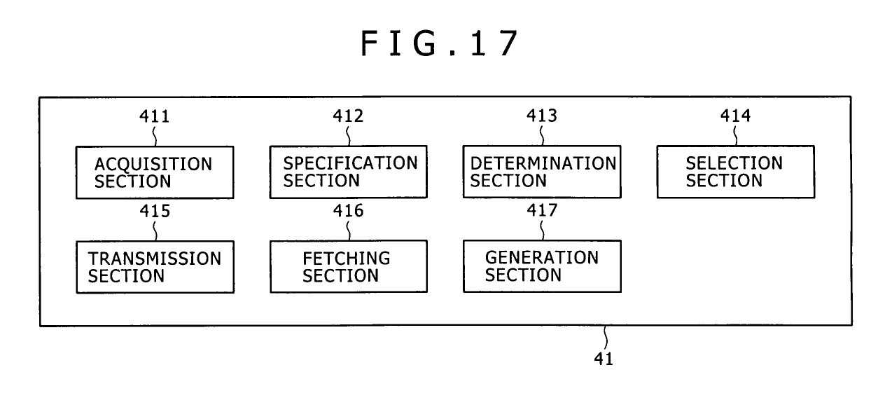

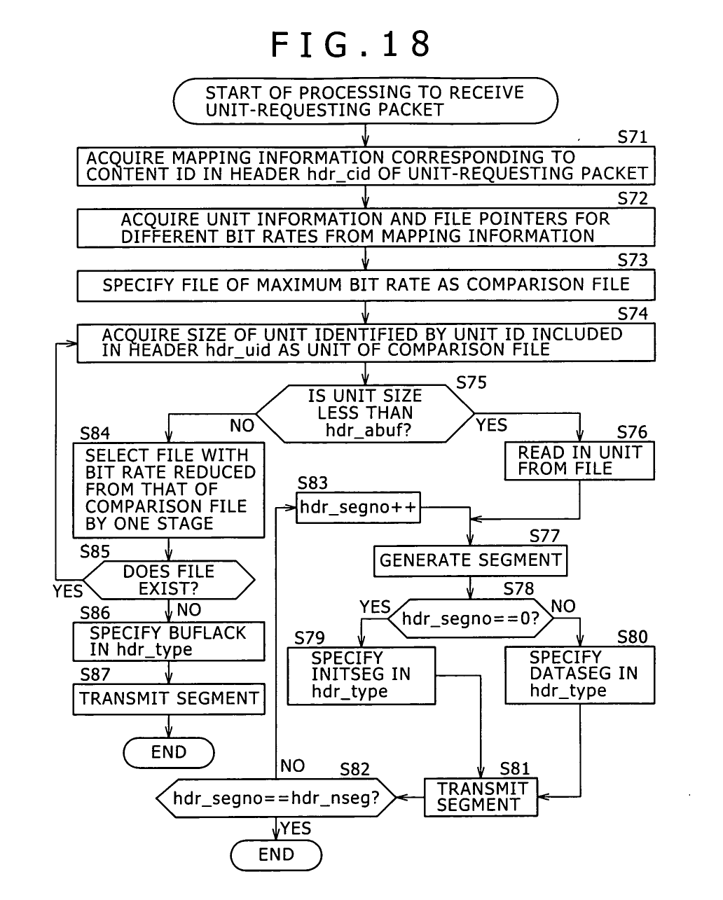

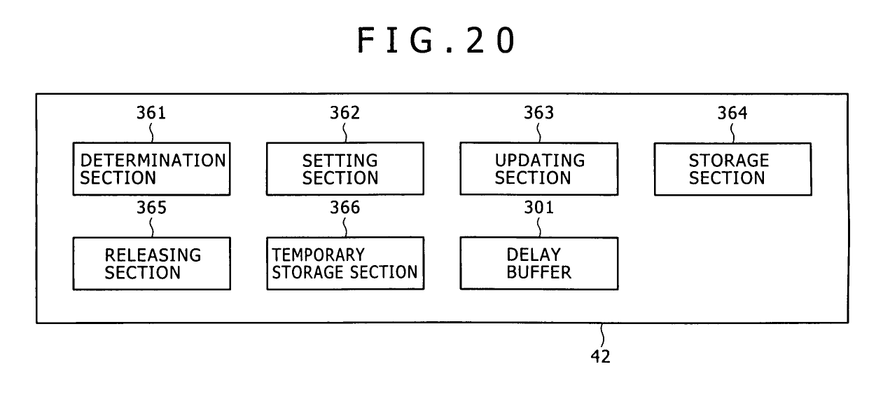

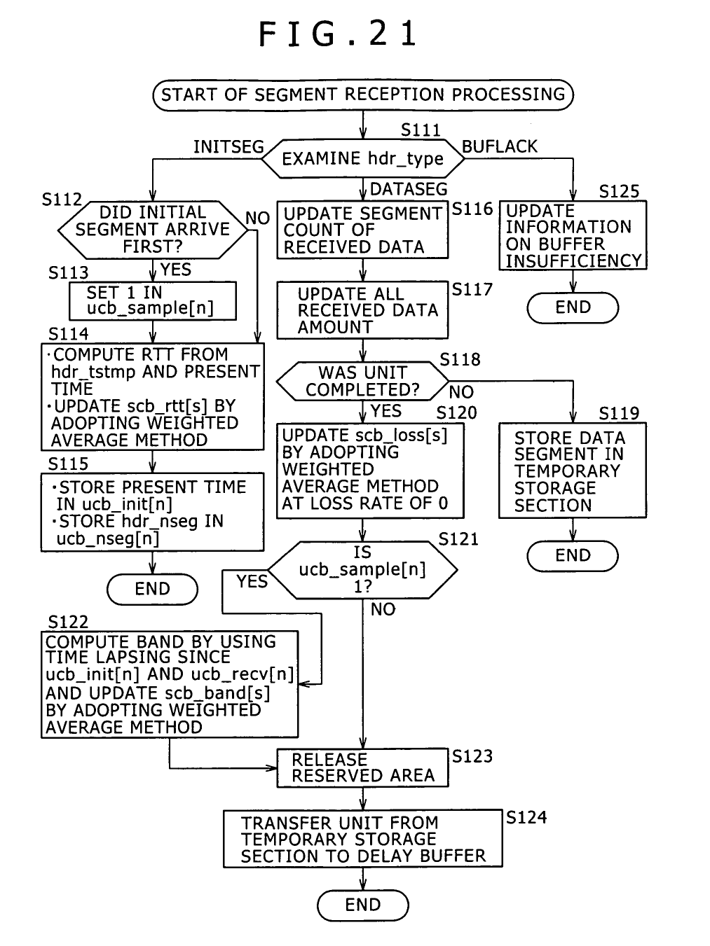

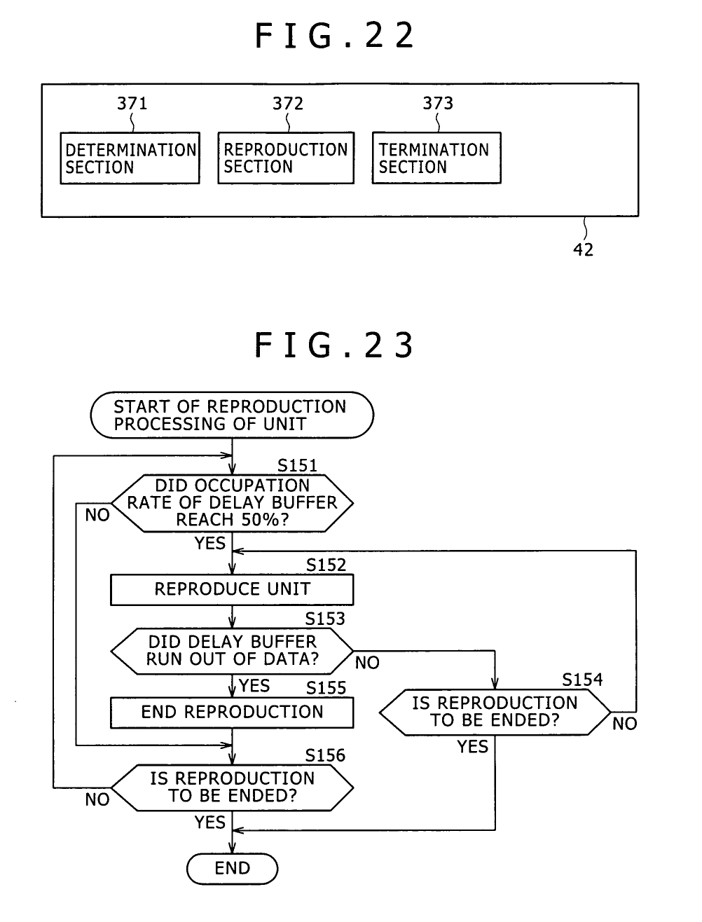

According to claim 1 of the present invention, there is provided an information-processing system (such as an information-processing system 40 shown in FIG. 5) for providing information from a first information-processing apparatus (such as a server 41-1 shown in FIG. 5) to a second information-processing apparatus (such as a client 42 shown in FIG. 5) by way of a network (such as the Internet 61 shown in FIG. 5) wherein:
the first information-processing apparatus includes:
   a reception section (such as an acquisition section 411 shown in FIG. 17 as a section for carrying out the process of a step S71 of a flowchart shown in FIG. 18) for receiving a request from the second information-processing apparatus as a request for information to be provided by the first information-processing apparatus; and
   a transmission section (such as a transmission section 415 shown in FIG. 17 as a section for carrying out the process of a step S81 of the flowchart shown in FIG. 18) for transmitting a file of the information to be provided by the first information-processing apparatus in processing units (such as process units) each decodable independently of the others of the processing units to the second information-processing apparatus; and
the second information-processing apparatus includes:
   an information-holding section (such as a delay buffer 301 shown in FIGS. 11 and 20 as a section for carrying out the process of a step S124 of a flowchart shown in FIG. 21) for holding the information transmitted by the first information-processing apparatus;
   an information-requesting section (such as a transmission section 337 shown in FIG. 14 as a section for carrying out the process of a step S37 of the flowchart shown in FIG. 16 on the basis of a determination result produced in a process carried out at a step S31 of the flowchart shown in FIG. 16) for managing the information held by the information-holding section and, in dependence on the amount of the information held by the information-holding section, issuing a request to the first information-processing apparatus as a request for transmission of the following information composing one of the processing units; and
   a reproduction section (such as a reproduction section 372 shown in FIG. 22 as a section for carrying out the process of a step S152 of a flowchart shown in FIG. 23) for reproducing the information in aforementioned processing units when the amount of the information held by the information-holding section becomes greater than a reference value set in advance (for example, when a determination result produced in a process carried out at a step S151 of the flowchart shown in FIG. 23 indicates that the rate of the occupation of the delay buffer 301 is greater than 50%) before all the processing units of the file are received.

It is possible to provide the information-processing system with a configuration wherein the transmission section divides each of the processing units into transmission units (such as segments), in which each of the processing units is transmitted from the first information-processing apparatus to the second information-processing apparatus. The second information-processing apparatus may further include a temporary storage section (such as a temporary storage section 366 shown in FIG. 20) for temporarily storing information transmitted by the first information-processing apparatus in transmission units and, when the number of transmission units stored in the temporary storage section reaches the number of transmission units composing a processing unit (for example, when a determination result produced in a process carried out at a step S118 of a flowchart shown in FIG. 21 indicates that a processing unit has been completed), the transmission units stored in the temporary storage section may be transferred to the information-holding section to be held therein (for example, in a process carried out at a step S124 of the flowchart shown in FIG. 21).

According to claim 5 of the present invention, there is provided an information-processing method adopted by an information-processing system (such as the information-processing system 40 shown in FIG. 5) for providing information from a first information-processing apparatus (such as the server 41-1 shown in FIG. 5) to a second information-processing apparatus (such as the client 42 shown in FIG. 5) by way of a network (such as the Internet 61 shown in FIG. 5), the information-processing method including a first information-processing method adopted by the first information-processing apparatus and a second information-processing method adopted by the second information-processing apparatus;
the first information-processing method including the steps of:
   receiving a request from the second information-processing apparatus as a request for information to be provided by the first information-processing apparatus (for example, a step S71 of the flowchart shown in FIG. 18); and
   transmitting a file of the information to be provided by the first information-processing apparatus in processing units (such as process units) each decodable independently of the others of the processing units to the second information-processing apparatus (for example, a step S81 of the flowchart shown in FIG. 18);
the second information-processing method including the steps of:
   holding the information transmitted by the first information-processing apparatus (for example, a step S124 of the flowchart shown in FIG. 21);
   managing the information held in a process carried out at the information-holding step and, in dependence on the amount of the information held in a process carried out at the information-holding step, issuing a request to the first information-processing apparatus as a request for transmission of the following information composing one of the processing units (for example, a step S37 of the flowchart shown in FIG. 16); and
   reproducing the information in aforementioned processing units when the amount of the information held in a process carried out at the information-holding step becomes greater than a reference value set in advance (for example, when a determination result produced in a process carried out at the step S151 of the flowchart shown in FIG. 23 indicates that the rate of the occupation of the delay buffer 301 is greater than 50%) before all the processing units of the file are received (for example, a step S152 of the flowchart shown in FIG. 23).

According to claim 6 of the present invention, there is provided an information-processing apparatus (such as the server 41-1 shown in FIG. 5) for receiving a request for information from an other information-processing apparatus (such as the client 42 shown in FIG. 5) by way of a network (such as the Internet 61 shown in FIG. 5) and transmitting the requested information to the other information-processing apparatus in accordance with the request by way of the network. The information-processing apparatus includes:
a reception section (such as the acquisition section 411 shown in FIG. 17 as a section for carrying out the process of the step S71 of the flowchart shown in FIG. 18) for receiving a request from the other information-processing apparatus as a request for one of processing units (such as process units) each decodable independently of the others of the processing units to be transmitted to the other information-processing apparatus as the requested one of the processing units composing a file of the requested information;
a transmission section (such as the transmission section 415 shown in FIG. 17 as a section for carrying out the process of a step S81 of the flowchart shown in FIG. 18) for dividing each of the processing units into transmission units and transmitting the information in aforementioned transmission units to the other information-processing apparatus; and
a determination section (such as a determination section 413 shown in FIG. 17 as a section for carrying out the process of a step S82 of the flowchart shown in FIG. 18) for:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting the transmission section to transmit a next one of the processing units in aforementioned transmission units if the reception section receives a request for the next processing unit.

It is possible to provide the information-processing apparatus with a configuration in which the transmission section transmits an empty segment virtually containing no information with a timing coinciding with the beginning of each of the processing units (for example, in a process carried out at a step S79 or S81 of the flowchart shown in FIG. 18).

According to claim 10 of the present invention, there is provided an information-processing method adopted by an information-processing apparatus (such as the server 41-1 shown in FIG. 5) for receiving a request for information from an other information-processing apparatus (such as the client 42 shown in FIG. 5) by way of a network (such as the Internet 61 shown in FIG. 5) and transmitting the requested information to the other information-processing apparatus in accordance with the request by way of the network. In addition, according to claims 11 and 12 of the present invention, there are also provided a computer program implementing the information-processing method and a recording medium for storing the computer program. The information-processing method includes the steps of:
receiving a request from the other information-processing apparatus as a request for one of processing units (such as process units) each decodable independently of the others of the processing units to be transmitted to the other information-processing apparatus as the requested one of the processing units composing a file of the requested information (for example, the step S71 of the flowchart shown in FIG. 18);
dividing each of the processing units into transmission units (such as segments) and transmitting the information in aforementioned transmission units to the other information-processing apparatus (for example, the step S81 of the flowchart shown in FIG. 18); and
executing the sub-steps (such as the step S82 of the flowchart shown in FIG. 18) of:
   determining whether or not transmission of all the transmission units composing a specific one of the processing units has been completed;
   terminating transmission of the specific processing unit if a determination result indicates that the transmission of all the transmission units composing the specific processing unit has been completed; and
   requesting to transmit a next one of the processing units in aforementioned transmission units in a process carried out at the unit-dividing and unit-transmitting step if a request for the next processing unit is received in a process carried out at the request-receiving step.

According to claim 13 of the present invention, there is provided an information-processing apparatus (such as the client 42 shown in FIG. 5) for requesting an other information-processing apparatus (such as the server 41-1 shown in FIG. 5) to provide information to the information-processing apparatus by way of a network (such as the Internet 61 shown in FIG. 5) and receiving the information from the other information-processing apparatus. The information-processing apparatus includes:
an information-holding section (such as the delay buffer 301 shown in FIGS. 11 and 20 as a section for carrying out the process of a step S124 of the flowchart shown in FIG. 21) for holding the requested information transmitted by the other information-processing apparatus by dividing a file of the information into processing units (such as process units) each decodable independently of the others of the processing units, further dividing each of the processing units into transmission units (such as segments) and transmitting each of the transmission units by way of the network;
a determination section (such as a determination section 332 shown in FIG. 14 as a section for carrying out the process of a step S31 of the flowchart shown in FIG. 16) for determining the amount of information held by the information-holding section as information of the processing units;
a unit-requesting section (such as the transmission section 337 shown in FIG. 14 as a section for carrying out the process of a step S37 of the flowchart shown in FIG. 16) for requesting the other information-processing apparatus to provide a next one of the processing units to the information-processing apparatus on the basis of a determination result produced by the determination section;
a request management section (such as a save section 335 shown in FIG. 14 as a section for carrying out the process of a step S35 of the flowchart shown in FIG. 16) for managing requests issued to the other information-processing apparatus; and
a reproduction section (such as the reproduction section 372 shown in FIG. 22 as a section for carrying out the process of a step S152 of the flowchart shown in FIG. 23) for reproducing the information in aforementioned processing units when the amount of the information held by the information-holding section becomes greater than a reference value set in advance (for example, when a determination result produced in a process carried out at the step S151 of the flowchart shown in FIG. 23 indicates that the rate of the occupation of the delay buffer 301 is greater than 50%) before all the processing units of the file are received.

It is possible to provide the information-processing apparatus with a configuration in which the request management section is capable of managing information (such as the ID of the server 41-1) for identifying other information-processing apparatus (such as the server 41-1), times (such as a timestamp described in hdr_tstmp of a header) at which the other information-processing apparatus is requested to transmit any one of the processing units and planned amounts (such as an advertised buffer size described in hdr_abuf of the header) of information to be held in the information-holding section.

It is possible to provide the information-processing apparatus with a configuration in which the unit-requesting section notifies the other information-processing apparatus of a planned amount (such as the smaller one of results obtained from processing carried out in accordance with Eqs. (1) and (2)) of information to be held in the information-holding section (for example, in a process carried out at a step S34 of the flowchart shown in FIG. 16) and the information-processing apparatus further includes an updating section (such as an updating section 336 shown in FIG. 14 as a section for carrying out the process of a step S36 of the flowchart shown in FIG. 16) for updating a reserved magnitude (such as a reserved buffer size stored in a variable named gcb_rsvbuf) of an amount of information to be held in the information-holding section on the basis of the planned amount of information reported to the other information-processing apparatus.

It is possible to provide the information-processing apparatus with a configuration in which the information-processing apparatus further includes a period-processing section (such as an updating section 363 shown in FIG. 20 as a section for carrying out the process of a step S114 of the flowchart shown in FIG. 21) for computing a period of time (such as a roundtrip time RTT) between issuance of a request for a processing unit to the other information-processing apparatus and reception of the requested processing unit when an empty segment virtually containing no information is received with a timing coinciding with the beginning of the requested processing unit (for example, when a determination result produced in a process carried out at a step S111 of a flowchart shown in FIG. 21 indicates that hdr_type of the header is INITSEG).

It is possible to provide the information-processing apparatus with a configuration in which the information-processing apparatus further includes:

a temporary storage section (such as the temporary storage section 366 shown in FIG. 20) for temporarily storing transmission units transmitted by the other information-processing apparatus till all transmission units of one processing unit are received from the other information-processing apparatus; and
a transfer section (such as a storage section 364 shown in FIG. 20 as a section for carrying out the process of a step S124 of the flowchart shown in FIG. 21) for transferring the transmission units stored in the temporary storage section to the information-holding section to be held therein as all transmission units of one processing unit are stored in the temporary storage section (for example, as a determination result produced in a process carried out at a step S118 of the flowchart shown in FIG. 21 indicates that a processing unit has been completed).

According to claim 20 of the present invention, there is provided an information-processing method adopted in an information-processing apparatus (such as the client 42 shown in FIG. 5) for requesting an other information-processing apparatus (such as the server 41-1 shown in FIG. 5) to provide information to the information-processing apparatus (that is, the client 42 shown in FIG. 5) by way of a network (such as the Internet 61 shown in FIG. 5) and receiving the information from the other information-processing apparatus (that is, the server 41-1 shown in FIG. 5). In addition, according to claims 21 and 22 of the present invention, there are also provided a computer program implementing the information-processing method and a recording medium for storing the computer program. The information-processing method includes the steps of:
holding the requested information transmitted by the other information-processing apparatus by dividing a file of the information into processing units (such as process units) each decodable independently of the others of the processing units, further dividing each of the processing units into transmission units (such as segments) and transmitting each of the transmission units by way of the network (for example, a step S124 of the flowchart shown in FIG. 21);
determining the amount of information held in a process carried out at the information-holding step as one of the processing units (for example, a step S31 of the flowchart shown in FIG. 16);
requesting the other information-processing apparatus to provide a next one of the processing units to the information-processing apparatus on the basis of a determination result produced in a process carried out at the determination step (for example, a step S37 of the flowchart shown in FIG. 16);
managing requests issued to the other information-processing apparatus (for example, a step S35 of the flowchart shown in FIG. 16); and
reproducing the information in aforementioned processing units when the amount of the information held in a process carried out at the information-holding step becomes greater than a reference value set in advance (for example, when a determination result produced in a process carried out at the step S151 of the flowchart shown in FIG. 23 indicates that the rate of the occupation of the delay buffer 301 is greater than 50%) before all the processing units of the file are received (for example, a step S152 of the flowchart shown in FIG. 23).

Embodiments of the present invention are described by referring to diagrams as follows. FIG. 2 is a diagram showing a typical configuration of an information-processing system 40 according to an embodiment of the present invention. As shown in the figure, the information-processing apparatus 40 comprises a server 41 and a client 42. The client 42 transmits a request for a content to be transmitted in a streaming transmission to the server 41. At this request, the server 41 transmits the content to the client 42 in a streaming transmission.

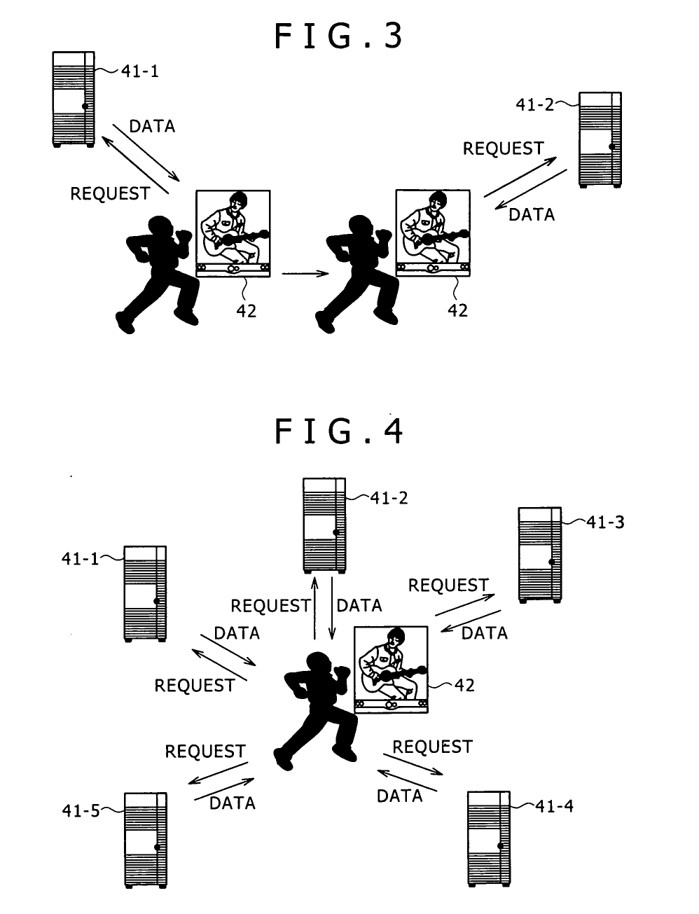

That is to say, in accordance with the present invention, streaming transmission of a pull implementation is carried out. As a result, even if the client 42 moves from a first location on the left side of the figure to a second location on the right side as shown in FIG. 3, the client 42 is capable of receiving a continuation of the content transmitted so far in a streaming transmission by a server 41-1 from another server 41-2, which holds the same content as the server 41-1. Also as shown in the same figure, at the first location, the client 42 has been receiving the content from the server 41-1 as a content transmitted in a streaming transmission.

FIG. 4 is a diagram showing a situation with more servers to provide the same content to a moving client. That is to say, FIG. 4 shows a multi-home/multi-server information-processing system in which a client 42 is capable of receiving the same content transmitted by any one of servers 41-1 to 41-5 in a streaming transmission in accordance with the present invention.

To put it concretely, in accordance with the present invention, an information-processing system 40 like one shown in FIG. 5 is created. As shown in the figure, the information-processing system 40 comprises servers 41-1 to 41-3 and a client 42, which are connected to each other through the Internet 61. As shown in FIG. 5, the client 42 is capable of moving to any other location if necessary and, at the other location, continuously receiving the same content transmitted in a streaming transmission from one of the servers 41-1 to 41-3. In other words, the servers 41-1 to 41-3 each have a function to transmit the same content to the client 42 in a streaming transmission of the pull implementation. It is to be noted that, if there is no need to distinguish the servers 41-1 to 41-3 from each other, the servers 41-1 to 41-3 are represented in the following description by a server 41, which is a generic name given to them.

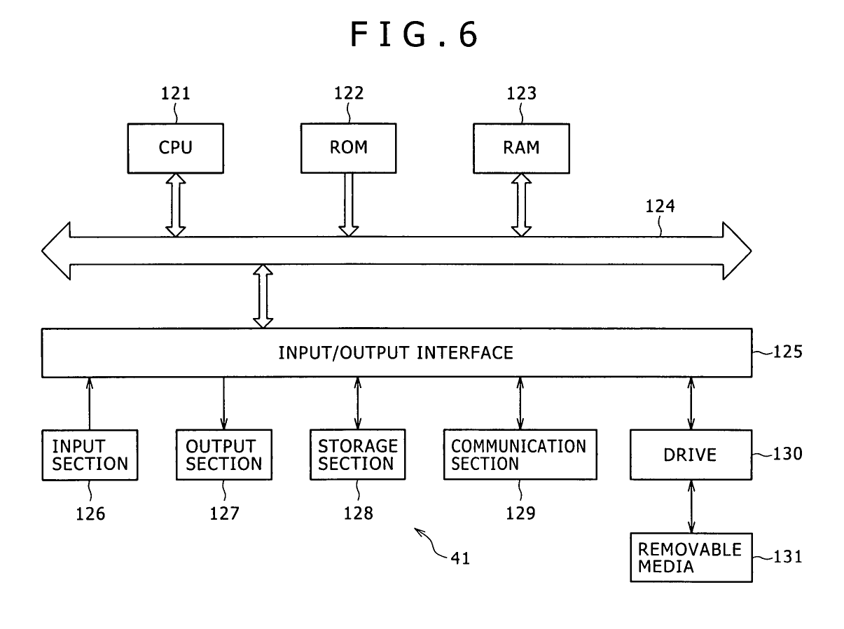

FIG. 6 is a diagram showing a typical configuration of the server 41.

In the configuration shown in FIG. 6, a CPU (Central Processing Unit) 121 carries out various kinds of processing by execution of programs stored in a ROM (Read Only Memory) 122 or loaded into a RAM (Random Access Memory) 123 from a storage unit 128. The RAM 123 is also used for properly storing data required by the CPU 121 in the execution of the processing.

The CPU 121, the ROM 122 and the RAM 123 are connected to each other by a bus 124, which is also connected to an input/output interface 125.

The input/output interface 125 is further connected to an input section 126, an output section 127, the storage section 128 cited above and a communication section 129. The input section 126 includes a keyboard or a mouse whereas the output section 127 comprises a display unit and a speaker. The display unit can be a CRT (Cathode Ray Tube) display unit or an LCD (Liquid Crystal Display) unit. The storage section 128 is typically a hard disk and the communication section 129 includes a modem. The communication section 129 is a component for carrying out communications by way of a network including the Internet 61.

If necessary, the input/output interface 125 is also connected to a drive 130, on which proper removable media 131 is mounted. Examples of the removable media 131 are a magnetic disk, an optical disk, a magneto-optical disk and a semiconductor memory. If necessary, a computer program is read out from the removable media 131 and installed in the storage section 128.

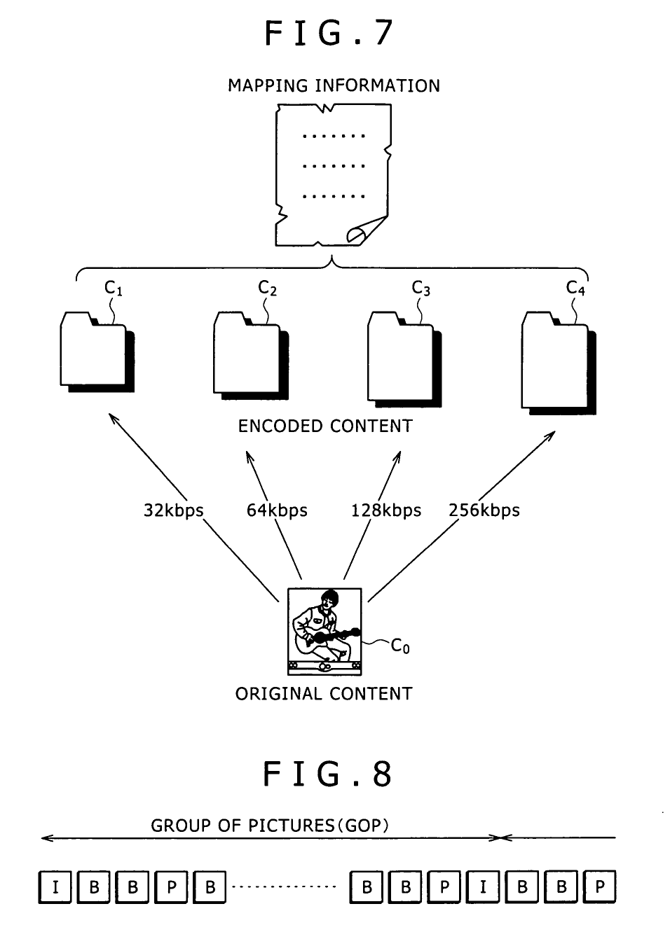

The storage section 128 employed in the server 41 is used for storing mapping information like one shown in FIG. 7 in advance. The mapping information comprises an original content C₀, encoded contents obtained as results of a process to encode the original content for different bit rates and pieces of information associated with the contents. To put it concretely, the typical mapping information shown in FIG. 7 comprises 4 types of encoded content described as follows. An encoded content C₁ is a content obtained as a result of a process to encode the original content C₀ for a bit rate of 32 kbps. By the same token, an encoded content C₂ is a content obtained as a result of a process to encode the original content C₀ for a bit rate of 64 kbps. An encoded content C₃ is a content obtained as a result of a process to encode the original content C₀ for a bit rate of 128 kbps in the same way. Similarly, an encoded content C₄ is a content obtained as a result of a process to encode the original content C₀ for a bit rate of 256 kbps.

The encoded contents C₁ to C₄ are each stored by dividing the content into processing units (or process units) each decodable independently of the others of the processing units. In the case of an encoded content obtained as a result of a process to encode the original content C₀ by adoption of a Motion-JPEG (Joint Photographic Experts Group) encoding technique, for example, frames composing the encoded content can each be used as the process unit. This is because, in accordance with the M-JPEG technique, an original content is encoded in frame units so that a frame can be decoded independently of other frames.

In addition, if an encoded content has been obtained as a result of a process to encode the original content C₀ by adoption of an MPEG (Moving Picture Experts Group) encoding technique, on the other hand, GOPs (Groups of Pictures) composing the encoded content can each be used as the process unit. This is because, in accordance with the MPEG technique, an original content is encoded in GOP units so that a GOP can be decoded independently of other GOPs.

That is to say, a GOP is a sequence of frames encoded by adoption of 3 different techniques for I, P and B pictures respectively as shown in FIG. 8. An I picture is a frame encoded not on the basis of correlations with other frames. Thus, as a frame, an I picture itself can be decoded. On the other hand, a P picture is a frame encoded by referring to an I or P picture leading ahead of the P picture being encoded on the time axis. Thus, as a frame, a P picture itself cannot be decoded unless the time-wise preceding I or P picture referred to in the encoding process has been decoded. A B picture is a frame encoded by referring to pictures lagging behind and leading ahead of the B picture being encoded on the time axis. Thus, as a frame, a B picture itself cannot be decoded unless the time-wise preceding and time-wise succeeding pictures referred to in the encoding process have been decoded.

As shown in FIG. 8, in the main profile of a GOP, 2 B pictures are placed between I or P pictures.

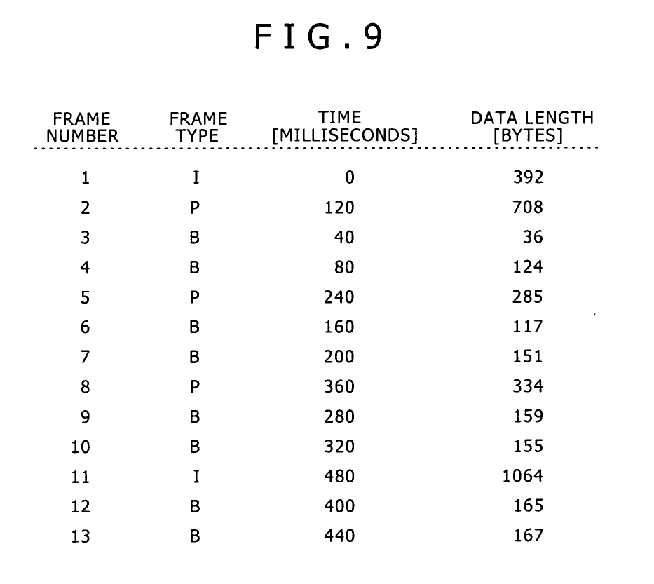

FIG. 9 is a diagram showing a typical sequence of frames composing 1 GOP as frames resulting from an encoding process adopting an MPEG4 technique. In this typical sequence, 13 frames compose 1 GOP. The 13 frames of the GOP are 2 I pictures, 3 P pictures and 8 B pictures.

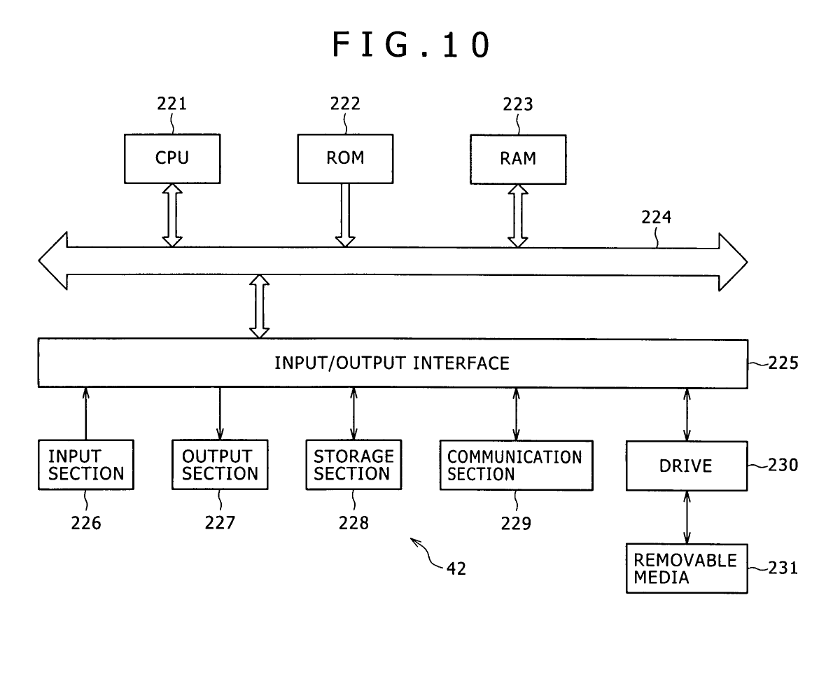

FIG. 10 is a diagram showing a typical configuration of the client 42. The basic configuration is the same as the server 41 shown in FIG. 6. That is to say, the client 42 also comprises components ranging from a CPU 221 to removable media 231. The components ranging from the CPU 221 to the removable media 231 have the same functions respectively as the components ranging from the CPU 121 to the removable media 131, which are employed in the server 41. That is to say, the components shown in FIG. 10 have the same functions as their respective counterpart components shown in FIG. 6.

A RAM 223 employed in the client 42 includes a delay buffer 301 shown in FIG. 11. The client 42 manages content data by storing ideally data of 10 process units (or processing units) stored in the delay buffer 301.

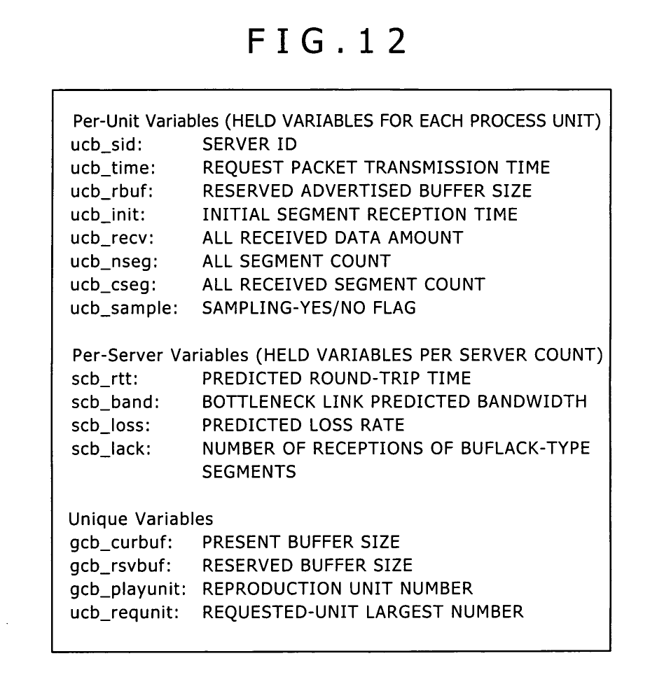

The RAM 223 is also used for storing variables shown in FIG. 12 as status information for managing data of a content received from the server 41.

In the information shown in FIG. 12, variable ucb_*** where *** represents a string of any characters is Per_Unit Variable held for each a process unit. Variable scb_*** where *** represents a string of any characters is Per_Server Variable held for each server. Variable gcb_*** where *** represents a string of any characters is global variables (Unique Variable).

Variable ucb_sid is a server ID identifying a server to which a packet used as a request for a process unit is transmitted. Variable ucb_time is a time at which a packet used as a request for a process unit is transmitted. Variable ucb_rbuf is a reserved advertised buffer size. Variable ucb_init is a time at which an initial segment of the process unit is received. Variable ucb_recv is the total amount of data of segments received so far. Variable ucb_nseg is the number of all segments composing a process unit. Variable ucb_cseg is the number of segments received so far as segments of a process unit. Variable ucb_sample is a flag indicating whether or not the first arriving segment is the initial segment. This flag is also a flag indicating whether or not an RTT (roundtrip time) to be described later is to be calculated, that is, whether or not sampling is to be carried out.

Variable scb_rtt is a predicted roundtrip time. Variable scb_band is a predicted bandwidth of a bottleneck link. Variable scb_loss is a predicted loss rate. Variable scb_lack is the number of received segments with a BUFLACK type to be described later.

Variable gcb_curbuf is the size of the present buffer or the size of a buffer available with the present timing. Variable gcb_rsvbuf is the size of a reserved buffer. Variable gcb_playunit is the number of a reproduction unit. Variable gcb_requnit is the largest number of a requested process unit among numbers assigned to a plurality of requested process units.

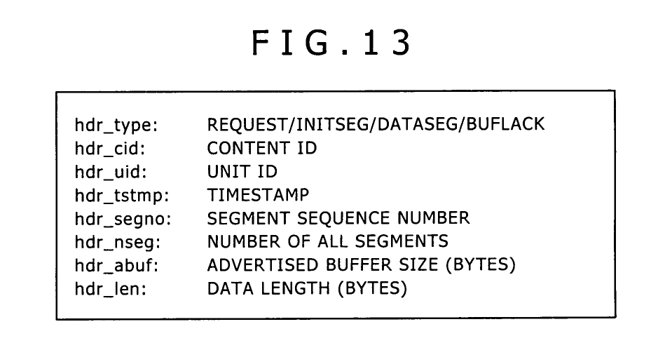

FIG. 13 is a diagram showing information described in the header of a packet exchanged between the client 42 and the server 41. hdr_type of the header is the type of the packet. hdr_type of the header can be REQUEST, INITSEG, DATASEG or BUFLACK. REQUEST indicates that the packet is a request packet used as a request for data. INITSEG indicates that the packet is a packet containing an initial segment. DATASEG indicates that the packet is a packet of a data segment. BUFLACK indicates that the packet is a packet used for indicating that it is feared that data cannot be stored in the delay buffer 301 due to an insufficient size of the delay buffer 301.

hdr_cid of the header is a content ID indicating a content. hdr_uid of the header is a unit ID indicating a process unit. hdr_tstmp of the header is a time stamp representing a time at which the segment included in the packet is transmitted. hdr_segno of the header is the sequence number of a segment requested by the packet. hdr_nseg of the header is the number of segments composing a process unit. hdr_abuf of the header is a byte count representing an advertised buffer size. hdr_len of the header is a byte count representing the amount of data in a segment requested by the packet.

In a 3SP (Stateless Server Streaming Protocol) according to the present invention, a list of servers each having a content that a client wants to acquire is held in advance for each client. Then, a client has the content ID of the content and the unit ID of a process unit in a packet used as a request for a process unit, transmitting the packet to the servers. In general, a plurality of servers is included on the list. In this case, a client transmits a prove packet to servers as a packet for measuring distances between the client and the servers. Then, the server measures a delay between the transmission of the prove packet and reception of a response to the packet from each of the servers. Subsequently, the client selects a server with a short delay. Finally, the client transmits a packet used as a request for a process unit to the selected server.

The client 42 transmits a packet used as a request for a process unit to the server 41 at predetermined intervals by carrying out processing represented by a flowchart to be described later by referring to FIG. 16. In order to transmit a packet used as a request for a process unit to the server 41 at predetermined intervals, the client 42 is provided with functions of sections shown in FIG. 14. As shown in FIG. 14, the sections are a time measurement section 331, a determination section 332, a setting section 333, a generation section 334, a save section 335, an updating section 336, a transmission section 337, a releasing section 338 and an initialization section 339.

The time measurement section 331 is a section for measuring time. The determination section 332 is a section for determining whether or not a predetermined period of time has been measured and the user has requested a termination. The determination section 332 is also a section for determining whether or not the utilization rate to be transmitted as the utilization rate of the delay buffer 301 and the unit number of a process unit to be transmitted exist.

The setting section 333 is a section for setting a variety of values in variables. The generation section 334 is a section for creating the header of a packet used as a request for a process unit. The save section 335 is a section for holding information on a connection with the server 41. The updating section 336 is a section for updating a reserved buffer size and a predicted loss rate. The transmission section 337 is a section for carrying out a process to transmit a packet used as a request for a process unit. The releasing section 338 is a section for carrying out a process to release a reserved area. The initialization section 339 is a section for carrying out a process to initialize information stored in variables held for every process unit.

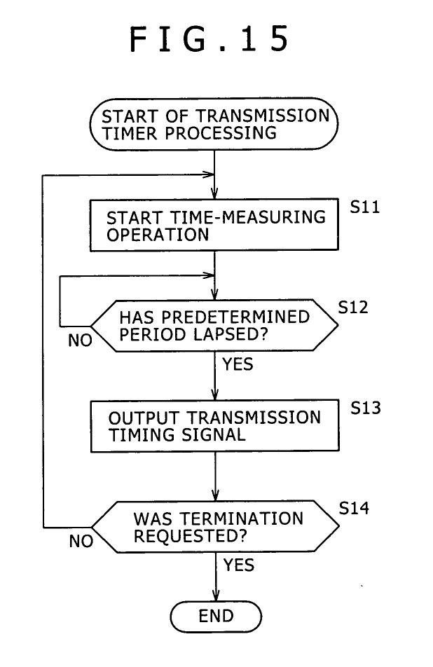

Next, transmission timer processing carried out by the client 42 is explained by referring to a flowchart shown in FIG. 15. This processing is started when the user of the client 42 operates the input section 226 to make an access to the server 41 and make a request for a content to be transmitted by the server 41 in a streaming transmission.

As shown in FIG. 15, the flowchart begins with a step S11 at which the time measurement section 331 starts a time-measuring operation. Then, at the next step S12, the determination section 332 determines whether or not a predetermined period of time has been measured. That is to say, the determination section 332 determines whether or not the predetermined period of time set in advance has lapsed since the start of the time-measuring operation carried out at the step S11 in a state of waiting for the predetermined period of time to lapse. The predetermined period of time is typically 500 milliseconds. The predetermined period of time is sufficiently short in comparison with the reproduction time of 1 process unit of a content transmitted in a streaming transmission. In this embodiment, 1 GOP of the MPEG4 technique is taken as the process unit. Since a typical minimum value of 1 GOP is about 1 second and the predetermined period of time is 500 milliseconds, the latter is sufficiently shorter than the former.

As a determination result produced in the process carried out at the step S12 indicates that the predetermined period of time has lapsed, the flow of the processing goes on to a step S13 at which the determination section 332 outputs a transmission timing signal. Every time the transmission timing signal is output, processing represented by a flowchart to be described later by referring to FIG. 16 is carried out as processing to transmit a packet used as a request for a process unit. Thus, in the case of this embodiment, at intervals of 500 milliseconds, the processing represented by the flowchart shown in FIG. 16 is carried out as processing to transmit a packet used as a request for a process unit.

Then, at the next step S14, the determination section 332 determines whether or not the user has issued a termination command. If the user has not issued a termination command, the flow of the processing goes back to the step S11 to repeat the operations described above. If a determination result produced in the process carried out at the step S14 indicates that the user has issued a termination command, on the other hand, the transmission timer processing is ended.

Next, processing carried out by the client 42 to transmit a packet used as a request for a process unit to a server 41 is explained by referring to a flowchart shown in FIG. 16. This processing is carried out every time a transmission timing signal is output in the process carried out at the step S13 of the flowchart shown in FIG. 15. Thus, this processing is carried out repeatedly in accordance with the transmission timing signal.

As shown in FIG. 16, the flowchart begins with a step S31 at which the determination section 332 determines whether or not the utilization rate of the delay buffer 301 is not greater than 90%. The utilization rate is defined as a ratio of the sum of a reserved buffer volume Brsv and the current buffer volume Bcur to a maximum buffer capacity Bmax. Thus, the utilization rate can be represented by the following expression: ((Brsv+Bcur)/Bmax).

The current buffer volume Bcur is a value set in variable gcb_curbuf in a process carried out at a step S124 of a flowchart to be explained later by referring to FIG. 21. The current buffer volume Bcur is the amount of data stored in the delay buffer 301 at the present time.

The reserved buffer volume Brsv is a value set in variable gcb_rsvbuf in a process carried out at a step S123 of the flowchart to be explained later by referring to FIG. 21. The reserved buffer volume Brsv is the amount of data in a process unit requested by using a unit-requesting packet transmitted previously. The reserved buffer volume Brsv corresponds to an advertised buffer size Badv computed by using Eq. (1) given below. In other words, when a new advertised buffer size Badv is reported to the server 41, the previous advertised buffer size Badv is used as the reserved buffer volume Brsv in a process carried out at a step S35 of the flowchart to be explained later by referring to FIG. 16.

$$Badv = \frac{B max - Bcur - Brsv}{\frac{{T}_{pref}}{{T}_{int}} - ( Cunt + Crsv )} \qquad ( 1 )$$

If a determination result produced in the process carried out at the step S31 indicates that the utilization rate of the delay buffer 301 is greater than 90%, the execution of the processing is ended. That is to say, in this case, sufficient content data has been stored in the delay buffer 301 so that further requests for content data are not made. Then, the execution of the processing is ended with a timing at 500 milliseconds later.

If a determination result produced in the process carried out at the step S31 indicates that the utilization rate of the delay buffer 301 is not greater than 90%, on the other hand, the flow of the processing goes on to a S32 at which a process to transmit a packet used as a request for a process unit is carried out as follows. At this step, the determination section 332 determines whether or not a unit number i of a specific process unit to be retransmitted by the server 41 exists. The specific process unit is a unit with an RTO (Round Timeout) of a TCP (Transmission Control Protocol) already lapsing. That is to say, the determination section 332 determines whether or not an unreceived process unit exists in spite of the fact that the transmission of a unit-requesting packet specifying the unit number i has been requested in a process carried out at a step S37 to be described later in previous execution of this flowchart.

To put it concretely, as the value of the RTO (Round Timeout), a value 4 times a predicted roundtrip time in variable scb_rtt is used. With regard to the unit number i, a lapsing time is computed as a difference between a transmission time of the packet used as a request for a process unit and the present time. The transmission time of the packet used as a request for a process unit is the value of variable ucb_time. If the time lapsing is found greater than the value of the RTO (Round Timeout), the unit number i is determined to exist.

However, it is necessary to have a unit number i is smaller than the value of variable gcb_playunit. Variable gcb_playunit is the number of a reproduction process unit to be retransmitted by the server 41 in a process carried out at a step S152 of a flowchart to be explained later by referring to FIG. 23. If the unit number i is greater than the number of a reproduction process unit to be retransmitted, there is no opportunity to reproduce the process unit any more. In this case, the unit number i is determined to be a non-existing unit number. That is to say, the unit number i is ignored. Thus, a request for transmission of a process unit can be prevented from becoming wasteful.

If the unit number i of a specific process unit to be retransmitted does not exist, the flow of the processing goes on to a step S33 at which the setting section 333 sets variable gcb_requnit in the requested-unit number n. Since variable gcb_requnit is the largest number of the requested process unit, this largest number of the requested process unit is set in the requested-unit number n. Thus, if there is a plurality of process units to be requested, a more recent process unit on the time axis is requested, taking precedence of other process units. Thus, a picture discontinuity caused by a missing most recent process unit can be avoided.

Then, at the next step S34, the generation section 334 creates the header of a packet used as a request for a process unit. To put it concretely, the generation section 334 stores the ID of a requested content in hdr_cid of the header and the ID of the requested process unit in hdr_uid of the header. The ID of the process unit is obtained from variable gcb_requnit. In addition, the generation section 334 sets the present time computed by the time measurement section 331 in hdr_tstmp of the header as a timestamp.

In addition, the generation section 334 computes the advertised buffer size Badv by using Eq. (1) described above and the TFR (TCP Friendly Rate) by using Eq. (2) given below. Then, the generation section 334 selects the smaller one of Badv and TFR, setting the smaller one in hdr_abuf of the header.

In Eq. (1), symbol Tᵢₙₜ denotes a period of time to reproduce a process unit and symbol T_{pref} denotes a period of time to reproduce all process units that can be held in the delay buffer 301. In the case of the embodiment, since the delay buffer 301 is capable of holding 10 process units, time period T_{pref} is set at a value 10 times time period Tᵢₙₜ. Thus, the value of T_{pref}/Tᵢₙₜ in Eq. (1) is 10.

Symbol Cunt in Eq. (1) denotes the number of process units stored in the delay buffer 301 at the point of time. In the case of the example shown in FIG. 11, the number of process units stored in the delay buffer 301 at the point of time is 6. Symbol Bcur is the number of bytes composing the process units stored in the delay buffer 301. On the other hand, symbol Crsv denotes the reserved buffer size in terms of process units whereas symbol Brsv denotes the reserved buffer size in terms of bytes.

Thus, Eq. (1) is used to find the advertised buffer size Badv as a ratio of an unused area of the delay buffer 301 to the number of storable process units. The unused area of the delay buffer 301 is represented by the expression (Bmax−Bcur−Brsv) whereas the number of storable process units is represented by the expression: (T_{pref}/Tᵢₙₜ−(Cunt+Crsv)).

If congestion control is not executed, the advertised buffer size Badv computed by using Eq. (1) is set in hdr_abuf of the header as it is. In this present invention, however, as a model of the congestion control with the highly reliable TCP, the so-called TFRC (TCP Friendly Rate Control) is adopted. Thus, in the present invention, a TFR (TCP Friendly Rate) expressed by Eq. (2) is computed. Then, the smaller one of the advertised buffer size Badv computed by using Eq. (1) and the TFR computed by using Eq. (2) is set in hdr_abuf of the header as advertised buffer size.

$$TFR = \frac{s}{R \sqrt{\frac{2 p}{3}} + {t}_{RTO} ( 3 \sqrt{\frac{3 p}{8}} ) p ( 1 + 32 {p}^{2} )} \qquad ( 2 )$$

It is to be noted that, in Eq. (2), symbol s denotes a packet size expressed in terms of bytes, symbol R denotes the RTT expressed in terms of seconds, symbol p denotes a loss rate and symbol T_{RTO} denotes the timeout value expressed in terms of seconds as the timeout value of the TCP. The loss rate p is a value derived by adoption of the weighted average method on the basis of samples computed for each round, which is defined as a period of time between a transmission of a packet used as a request for a process unit and a reception of the requested packet. Since a missing packet used as a request for a process unit is subjected to back-off congestion control, such a missing packet is not reflected in the loss rate.

The TFR is used at intervals between transmissions of packets each used as a request for a process unit because the fact that a bottleneck link cannot be processed within an interval between transmissions of such packets implies that a reproduction speed is higher than a data acquisition speed. For example, even if the delay buffer 301 is capable of providing sufficient data by a reproduction time, the longer the data time, the more the buffering operation becomes incapable of following the need for the data. It is thus quite within the bounds of possibility that the reproduction of the data in the client 42 is stopped. For this reason, in the 3SP of the present invention, basically, data transfers relying on the buffering are not carried out.

As described above, by taking the TFR into consideration, communications of other apparatus can be prevented from being affected excessively due to traffic congestions in the Internet 61.

Then, at the next step S35, the save section 335 carries out a process to hold connection information. That is to say, since a content is transmitted in a streaming transmission of the pull implementation in this embodiment, the client 42 manages connections with servers 41 by itself. To put it concretely, the client 42 stores the ID of a server accessed by the client 42 in variable ucb_sid. In addition, the client 42 stores a timestamp set in hdr_tstmp of the header in variable ucb_time and the value of hdr_abuf of the header in variable ucb_rbuf. As described above, the present time is set as the timestamp in the process carried out at the step S34. Thus, at the step S35, the advertised buffer size Badv stored in the hdr_abuf of the header or the TFR is stored in variable ucb_rbuf.

Then, at the next step S36, the updating section 336 carries out a process to update the reserved buffer size. To put it concretely, the value of variable ucb_rbuf representing the reserved advertised buffer size is added cumulatively to the value of variable gcb_rsvbuf representing the reserved buffer size.

Then, at the next step S37, the transmission section 337 transmits a packet used as a request for a process unit. The packet used as a request for a process unit has been generated in the process carried out at the step S34 to the server 41. The packet used as a request for a process unit is transmitted to the server 41 by way of the Internet 61.

If the determination result produced in the process carried out at the step S32 indicates that a unit number i of a specific process unit to be retransmitted exists, on the other hand, the flow of the processing goes on to a step S38. As described earlier, the specific process unit is a unit with an RTO (Round Timeout) of the TCP (Transmission Control Protocol) lapsing. At the step S38, the updating section 336 finds a loss rate by sampling computation using variable ucb_cseg representing the number of segments received so far and variable ucb_nseg representing the number of all segments. In addition, the updating section 336 carries out a process to update variable scb_loss representing a loss rate by adoption of the weighted average method obtained as a result of the sample computation.

Assume for example a unit-receiving process in which the value of variable ucb_nseg[i] representing the number of all segments is 10. At a point of time the value of variable ucb_cseg[i] representing the number of segments received so far reaches 8, a timeout occurs. In this case, a sample of the loss rate of a server indicated by an ID stored in variable ucb_sid[i] as a server requested to transmit a process unit is represented by the following expression:

$$( ucb\_nseg [ i ] - ucb\_cseg [ i ] ) / ucb\_nseg [ i ] = ( 10 - 8 ) / 10 = 0.2 \qquad ( 3 )$$

In this case, the loss rate represented by variable scb_loss[ucb_sid[i]] is updated by adoption of the weighted average method in accordance with the following equation:

$$scb\_loss [ ucb\_sid [ i ] ] = scb\_loss [ ucb\_sid [ i ] ] \times ( 1 - α ) + 0.2 \times α \qquad ( 4 )$$

It is to be noted that the constant a used in the weighted average method is a value in the range 0 to 1. A typical value of the constant α is 0.9. Of course, another value in the range can also be used.

Then, at the next step S39, the releasing section 338 releases a reserved area. To put it concretely, the value of variable ucb_rbuf representing the reserved advertised buffer size is subtracted from the value of variable gcb_rsvbuf representing the reserved buffer size. That is to say, the reserved buffer size is reduced by the quantity added in the process carried out at the step S36.

Then, at the next step S40, the initialization section 339 initializes all variables held for each process unit (that is, Per-Unit Variables shown in FIG. 12). That is to say, the initialization section 339 initializes variables ucb_sid, ucb_time, ucb_rbuf, ucb_init, ucb_recv, ucb_nseg, ucb_cseg and ucb_sample.

Then, at the next step S41, the setting section 333 sets i in the requested-unit number n. Subsequently, the flow of the processing goes on to the step S34 at which the generation section 334 creates the header of a packet used as a request for a process unit. Then, at the next step S35, the save section 335 carries out a process to hold connection information. Subsequently, at the next step S36, the updating section 336 carries out a process to update the reserved buffer size. Then, at the next step S37, the transmission section 337 transmits a unit-requesting packet generated in the process carried out at the step S34 to the server 41.

In response to the processing carried out by the client 42 to transmit a packet used as a request for a process unit to the server 41, the server 41 carries out processing to receive the unit-requesting packet. In order to carry out the processing to receive the packet used as a request for a process unit, the server is provided with a functional configuration like one shown in FIG. 17.

As shown in the figure, the server 41 comprises an acquisition section 411, a speciication section 412, a determination section 413, a selection section 414, a transmission section 415, a fetching section 416 and a generation section 417.

The acquisition section 411 is a section for receiving a packet used as a request for a process unit from the client 42 and acquiring necessary data included in the packet. In addition, the acquisition section 411 also carries out a process to acquire file pointers for different bit rates and information on the requested process unit from mapping information as well as a process to acquire the size of the process unit for an acquired file. The speciication section 412 is a section for specifying a file of the largest bit rate as a comparison file and specifies various kinds of data in the header. A comparison file is a file containing a process unit, the size of which is to be compared with an advertised buffer size specified in the header of a packet used as a request for a process unit.

The determination section 413 is a section for carrying out processes to determine a unit size, to determine whether or not a file exist and determine values in the header. The selection section 414 is a section for selecting a file from the files of different bit rates. The transmission section 415 is a section for carrying out a process to transmit a segment to the client 42. The fetching section 416 is a section for carrying out a process to read in a process unit from a file. The generation section 417 is a section for carrying out a process to generate a segment.

By referring to a flowchart shown in FIG. 18, the following description explains processing carried out by the server 41 to receive a packet used as a request for a process unit from the client 42. This processing is carried out in response to a packet received from the client 42 as the packet used as a request for a process unit.

As shown in the figure, the flowchart begins with a step S71 at which the acquisition section 411 receives a packet used as a request for a process unit from the client 42. Then, the acquisition section 411 acquires mapping information corresponding to a content ID included in hdr_cid of the header of the received packet used as a request for a process unit. As explained earlier, hdr_cid of the header is created in a process carried out at the step S34 of the flowchart shown in FIG. 16.

Subsequently, at the next step S72, the acquisition section 411 acquires information on the requested process unit and file pointers for different bit rates from the mapping information obtained in the process carried out at the step S71. As the mapping information, files for 4 different bit rates are available as shown in FIG. 7. Thus, the acquisition section 411 obtains the file pointers pointing to the 4 files respectively. Since each of the files is further divided into process units, the acquisition section 411 also acquires a unit pointer pointing to a process unit in a file. It is to be noted that the process-unit information acquires from the packet used as a request for a process unit includes a unit ID described in hdr_uid of the header of the packet and an advertised buffer size described in hdr_abuf of the header of the packet.

Then, at the next step S73, the speciication section 412 specifies a file of the largest bit rate as a comparison file. In the case of this embodiment, the file of the largest bit rate corresponds to an encoded content of 256 kbps as shown in FIG. 7. Thus, the speciication section 412 specifies the encoded content of 256 kbps as a comparison file.

Subsequently, at the next step S74, the acquisition section 411 acquires the size of a process unit identified by a unit ID included in hdr_uid of the header as a unit of the comparison file specified in the process carried out at the step S73. This size is generated and stored as part of the mapping information from the beginning at the same time as the time at which the acquisition section 411 generates the encoded content C₄ in the server 41.

Then, at the next step S75, the determination section 413 determines whether of not the size of the process unit is less than a value described in hdr_abuf of the header. That is to say, the determination section 413 determines whether of not the unit size acquired in the process carried out at the step S74 is less than the advertised buffer size described in hdr_abuf of the header as a value obtained in the process carried out at the step S72. If the size of the process unit is smaller than the advertised buffer size described in hdr_abuf of the header, the server 41 can transmit the process unit to the client 42 and the client 42 is capable of storing the process unit in the delay buffer 301 and properly reproducing the process unit. Thus, in this case, the flow of the processing goes on to a step S76, at which the fetching section 416 caries out a process to read in a process unit identified by a unit ID described in hdr_uid of the header from the file. As a result, the fetching section 416 obtains a process unit identified by a unit ID described in hdr_uid of the header from the file as a process unit requested by the client 42. Then, the fetching section 416 sets 0 in header hdr_segno representing the sequence number of a segment in the process unit as follows: (hdr_segno=0).

Then, at the next step S77, the generation section 417 generates a segment. To put it concretely, the generation section 417 divides the process unit into a plurality of segments. If the process unit has already been divided into a plurality of segments, of course, the generation section 417 merely carries out a process to virtually select one of the existing segments. Then, the generation section 417 sets the number of segments composing the process unit in hdr_nseg of the header of a packet to be transmitted to the client 42. In addition, the generation section 417 sets the sequence number of the segment in hdr_segno of the header of the packet. As described above, hdr_segno represents the sequence number of a segment. In the case of the present segment, the sequence number is set at 0 in the process carried out at the step S76. On the top of that, the generation section 417 sets the length of data of the segment in hdr_len of the header of the packet.

If the value of hdr_segno of the header is set at 0, the segment to be transmitted to the client 42 is an initial segment. Thus, virtually, the segment does not include data. That is to say, since the initial segment is an empty segment, hdr_len of the header of the packet is also set at 0. Information such as the number of all segments and the data length is described in advance in the mapping information held by the server 41.

Then, at the next step S78, the determination section 413 determines whether or not the value of hdr_segno of the header is 0. In the case of the current segment, since the value of hdr_segno of the header has been set at 0, the flow of the processing goes on to a step S79 at which the speciication section 412 sets INITSEG in hdr_type of the header. INITSEG set in hdr_type of the header indicates that the segment currently generated is an initial segment. Then, at the next step S81, the transmission section 415 transmits the segment to the client 42. This segment is transmitted to the client 42 as a packet.

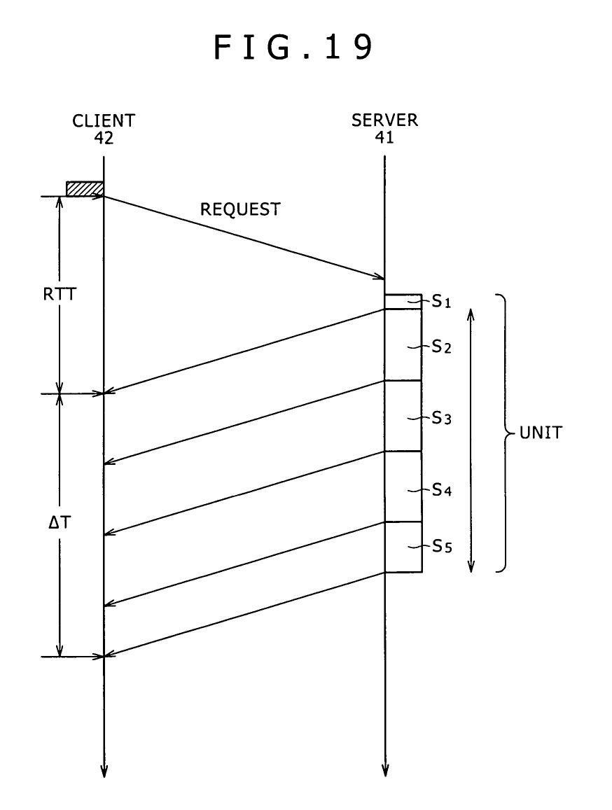

In this way, the server 41 transmits an initial segment S₁ to the client 42 in response to the unit-requesting packet received by the server 41 from the client 42 as shown in FIG. 19.

Subsequently, at the next step S82, the determination section 413 determines whether or not the value of hdr_segno of the header is equal to the value of hdr_nseg of the header. In the case of the current segment, the value of hdr_segno of the header has been set at 0 whereas the value of hdr_nseg of the header is the number of all segments composing the process unit. Thus, the value of hdr_segno of the header is not equal to the value of hdr_nseg of the header. In this case, the flow of the processing goes on to a step S83 at which the generation section 417 increments the value of hdr_segno of the header. Since the value of hdr_segno of the header is 0 in the case of the current segment, the value of hdr_segno of the header is incremented to 1. Then, at the next step S77, the generation section 417 again carries out a process to generate a segment. In this process, the generation section 417 sets the number of segments composing the process unit in hdr_nseg of the header of the packet. However, the number of segments composing the process unit does not change. In addition, the generation section 417 also sets the sequence number of the segment in hdr_segno of the header of the packet. In the case of this newly generated segment, the generation section 417 sets hdr_segno of the header of the packet at 1 as the sequence number of the segment. On the top of that, the generation section 417 sets the length of data of the segment in hdr_len of the header of the packet.

Then, at the next step S78, the determination section 413 determines whether or not the value of hdr_segno of the header is 0. In the case of the newly generated segment, since the value of hdr_segno of the header has been set at 1, the flow of the processing goes on to a step S80 at which the generation section 417 specifies DATASEG in hdr_type of the header of the packet to indicate that the segment included in the packet is a data segment. The generation section 417 stores the segment indicated by a segment number of 1 in the data portion (that is, the so-called payload) of the packet. Then, at the next step S81, the transmission section 415 transmits the segment generated in this way to the client 42 as a packet.

Subsequently, at the next step S82, the determination section 413 determines whether or not the value of hdr_segno of the header is equal to the value of hdr_nseg of the header. In the case of the current segment, the value of hdr_segno of the header has been set at 1 whereas the value of hdr_nseg of the header is the number of all segments composing the process unit. Thus, the value of hdr_segno of the header is not equal to the value of hdr_nseg of the header. In this case, the flow of the processing goes on to the step S83 at which the generation section 417 increments the value of hdr_segno of the header from 1 to 2.

Thereafter, the same processes are carried out repeatedly to transmit segments composing the process unit sequentially one segment after another. As the determination result produced in the process carried out at the step S82 indicates that the value of hdr_segno of the header is equal to the value of hdr_nseg of the header, the execution of the processing is ended. As described above, the value of hdr_segno of the header is the sequence number of the segment whereas the value of hdr_nseg of the header is the number of all segments composing the process unit. After the execution of the processing is ended, the server 41 does not transmit a new process unit in segment units to the client 42 till a request for another process unit is again received from the client 42.

If the determination result produced in the process carried out at the step S75 indicates that the size of the process unit indicated by a unit ID described in hdr_uid of the packet is equal to or greater than a value described in hdr_abuf of the header, on the other hand, the flow of the processing goes on to a step S84 at which the selection section 414 selects a file with a bit rate reduced from that of the comparison file specified in the process carried out at the step S73 by one level stage. This is because if the data of the process unit is transmitted to the client 42 as it is, the data will be too much for the client 42 so that it is feared that the client 42 is not capable of processing the data in a real-time manner. To put it concretely, if the present comparison file is the file of the encoded content C₄ encoded for 256 kbps, the present comparison file is changed to the file of the encoded content C₃ encoded for 128 kbps in the process carried out at the step S84.

Then, at the next step S85, the determination section 413 determines whether or not the file selected in the process carried out at the step S84 as the file of a content encoded for a bit rate reduced by one level stage exists. If such a file exists, the flow of the processing goes back to the step S74 at which the acquisition section 411 acquires the size of a process unit identified by a unit ID included in hdr_uid of the header as a unit of the comparison file specified in the process carried out at the step S84. Then, at the next step S75, the determination section 413 determines whether of not the size of the process unit is less than a value described in hdr_abuf of the header. That is to say, the determination section 413 determines whether of not the unit size acquired in the process carried out at the step S74 is less than the advertised buffer size described in hdr_abuf of the header as a value obtained in the process carried out at the step S72. If the size of the process unit is equal to or greater than the advertised buffer size described in hdr_abuf of the header, the flow of the processing goes on to the step S84 at which the selection section 414 again selects a file with a bit rate reduced from that of the comparison file specified previously in the process carried out at the step S84 by another level stage.

As described above, a comparison file of each of the encoded contents C₃, C₂ and C₁ is examined sequentially for one content after another till a comparison file is found as a file for which the size of the process unit is smaller than the advertised buffer size described in hdr_abuf of the header. As the determination result produced in the process carried out at the step S75 indicates that the size of the process unit is smaller than the advertised buffer size described in hdr_abuf of the header, the processes of the step S76 and the subsequent steps are carried out again to transmit data of the process unit to the client 42 in segment units sequentially one segment after another.

As described above, by taking an allowable transfer capacity of the client 42 into consideration, the server 41 is capable of transmitting data to the client 42 with the highest degree of efficiency.

If the determination result produced in the process carried out at the step S85 indicates that the file selected in the process carried out at the step S84 as the file of a content encoded for a bit rate reduced by one stage does not exist, that is, if the size of the process unit is greater than the advertised buffer size described in hdr_abuf of the header even for the encoded content C₁ encoded for the minimum bit rate in the example shown in FIG. 7, on the other hand, the flow of the processing goes on to a step S86, at which the specification section 412 specifies BUFLACK in hdr_type of the header, and the server 41 transmits the packet to the client 42 to indicate that the capacity of the delay buffer 301 employed in the client 42 is not enough. This is because, as described above, the size of the process unit is greater than the advertised buffer size described in hdr_abuf of the header even for the content C₁ encoded for the minimum bit rate. Thus, it is feared that the client 42 is not capable of receiving the content transmitted continuously in a streaming transmission and, in consequence, the processing to reproduce pictures is discontinued in the course of reproduction. Then, at the next step S87, the transmission section 415 transmits a segment to the client 42 as a packet with BUFLACK specified in hdr_type of the header.

As described above, after the server 41 transmits the initial segment S₁ to the client 42, the server 41 transmits the second segment S₂, the third segment S₃ and the subsequent segments sequentially one segment after another as shown in FIG. 19. Then, after the last one of segments composing the process unit is transmitted to the client 42, the execution of the processing to transmit the process unit to the client 42 is ended. In the case of the example shown in FIG. 19, the last segment is the fifth segment S₅.

As described above, the server 41 transmits a process unit specified by the client 42 to the client 42 by dividing the process unit into segments and transmitting the process unit in segment units.

It is to be noted that, when the server 41 transmits data to the client 42, the server 41 transmits the data by dividing the data into segments, which are each included in a packet, in accordance with a transport-layer protocol such as a UDP (User Datagram Protocol) or the TCP. In this case, the data of each segment is set in advance at such an amount that the segment can be accommodated in a packet. As a result, the server 41 transmits every segment as a packet to the client 42 so that data can be exchanged by way of the Internet 61 with ease.

The following description explains processing carried out by the client 42 to receive a segment transmitted by the server 41. In order to carry out this processing, the client 42 is provided with a functional configuration like one shown in FIG. 20. As shown in the figure, the client 42 has a determination section 361, a setting section 362, an updating section 363, a storage section 364, a releasing section 365 and a temporary storage section 366 in addition to the delay buffer 301. It is to be noted that the functional configuration shown in FIG. 20 is actually integrated with the functional configuration shown in FIG. 14.

Thus, sections shown in FIG. 14 can be integrated with those shown in FIG. 20. For example, the determination section 332, setting section 333, updating section 336 and releasing section 338 shown in FIG. 14 can actually be integrated with respectively the determination section 361, setting section 362, updating section 363 and releasing section 365 shown in FIG. 20.

The determination section 361 is a section for carrying out processes to examine the contents of a header, determine whether or not the initial segment has arrived first and determine whether or not all segments of a requested process unit have been received. The setting section 362 is a section for setting predetermined values in variables. The updating section 363 is a section for updating contents of variables and a header. The storage section 364 is a section for carrying out a process to transfer and/or store data at a location properly determined in advance. The releasing section 365 is a section for releasing a reserved area. The temporary storage section 366 is a section used for temporarily storing data segments till data of one process unit is collected.

By referring to a flowchart shown in FIG. 21, the following description explains processing carried out by the client 42 to receive a segment from the server 41. This processing is carried out in response to the processing explained earlier by referring to the flowchart shown in FIG. 18 as processing performed by the server 41 to receive a packet used as a request for a process unit from the client 42. In turn, the processing explained earlier by referring to the flowchart shown in FIG. 18 is carried out in response to the processing explained earlier by referring to the flowchart shown in FIG. 16 as processing performed by the client 42 to transmit the packet used as a request for a process unit to the server 41.

As shown in FIG. 21, the flowchart begins with a step S111 at which the determination section 361 examines hdr_type of the header of a packet received from the server 41. If hdr_type of the header is INITSEG, the flowchart goes on to a step S112. If hdr_type of the header is DATASEG, the flowchart goes on to a step S116. If hdr_type of the header is BUFLACK, the flowchart goes on to a step S125.

In addition, at the step S111, the determination section 361 sets a unit ID described in hdr_uid of the header in a variable n and a server ID described in hdr_sid of the header in a variable s.

As described above, if hdr_type of the header is INITSEG, that is, if the segment received currently is the initial segment, the flowchart goes on to the step S112 at which the determination section 361 determines whether or not the initial segment has arrived as the first segment. To put it concretely, the determination section 361 determines whether or not the total amount of received data in variable ucb_recv is 0. That is to say, as described earlier, the initial segment virtually contains no content data but segments other than the initial segment each contain content data. The amount of data contained in a segment is stored cumulatively in variable ucb_recv. Thus, the fact that the total amount of received data in variable ucb_recv is 0 implies that the initial segment has arrived as the first segment or a segment containing content data has not been received so far. In this case, the flowchart goes on to a step S113 at which the setting section 362 sets the value of 1 in variable ucb_sample, which is a flag indicating whether or not the initial segment has arrived as the first segment. Variable ucb_sample is also a flag indicating whether or not a sampling operation can be carried out as a process to detect the band of the network upon completion of the reception of the process unit. If the flag has been set at 1, at a step S122 to be described later, a process is carried out to update variable scb_band representing the band of a bottleneck. If the flag has been set at a value other than 1, on the other hand, the process to update variable scb_band is skipped.

If the determination result produced in the process carried out at the step S112 indicates that the initial segment has arrived not as the first segment, on the other hand, the flowchart goes on to a step S113, skipping the process carried out at the step S113 to set the value of 1 in variable ucb_sample. Thus, the flowchart goes on to the step S114 from the step S113 for setting the value of 1 in variable ucb_sample or from the step S112 if the determination result produced in the process carried out at the step S112 indicates that the initial segment has arrived not as the first segment. At the step S114, the updating section 363 carries out a process to compute the RTT from hdr_tstmp of the header and the present time. hdr_tstmp of the header is a time at which a packet used as a request for a process unit is transmitted. This time at which a packet used as a request for a process unit is transmitted is set in hdr_tstmp of the header as a timestamp in a process carried out at the step S34 of the flowchart shown in FIG. 16. Thus, the RTT is a difference between the packet transmission time and a time at which the initial segment is received from the server 41 as shown in FIG. 19. The time at which the initial segment is received from the server 41 is the present time.

In addition, the updating section 363 carries out a process to update variable scb_rtt representing the predicted roundtrip time by adoption of the weighted average method.

For example, as a time at which a packet used as a request for a process unit is transmitted, a timestamp of 1202300 milliseconds is set in hdr_tstmp of the header. This timestamp is an internal clock value. On the other hand, the time at which the initial segment is received from the server 41 is 1203400 milliseconds. In this case, the RTT sample is found to be 1,100 (=1203400−1202300) milliseconds. The RTT is then found by adoption of the weighted average method in accordance with the following equation:
scb_{—}rtt[s]=scb_{—}rtt[s]×(1−α)+1100×α (5)

Then, at the next step S115, the storage section 364 stores the present time in variable ucb_init. Thus, variable ucb_init contains the time at which the initial segment is received from the server 41. In addition, the storage section 364 also stores hdr_nseg of the header in variable ucb_nseg[n]. As described earlier, hdr_nseg of the header is the number of all segments composing the process unit, and this segment count is stored in variable ucb_nseg[n].

In this way, the number of all segments composing the process unit is stored in variable ucb_nseg[n].

If the determination result produced in the process carried out at the step S111 indicates that hdr_type of the header is DATASEG, the flowchart goes on to the step S116 at which the updating section 363 carries out a process to update the number of segments composing the received data. To put it concretely, the number of segments composing the received data is added cumulatively to the number of segments received so far to update variable ucb_cseg representing the number of all received segments. Thus, variable ucb_cseg represents the number of segments received so far.

Then, at the next step S117, the updating section 363 carries out a process to update the amount of all received data. To put it concretely, the value of hdr_len of the header is added cumulatively to variable ucb_recv. Since the value of hdr_len of the header is the length of data included in a segment included in a packet containing the header, a cumulative sum of lengths of data included in received segments is stored in variable ucb_recv.

Then, at the next step S118, the determination section 361 determines whether or not all segments composing the requested process unit have been received. To put it concretely, the determination section 361 compares the value of variable ucb_nseg representing the number of all segments as a segment count stored in the process carried out at the step S115 with variable ucb_cseg representing the number of segments of received data as a segment count updated in the process carried out at the step S116. If both are not equal to each other, the flow of the processing goes on to a step S119 at which the storage section 364 stores the data segment in the temporary storage section 366.

Since the client 42 carries out the processing represented by the flowchart shown in FIG. 21 when a segment is received from the server 41, data segments are stored sequentially in the temporary storage section 366 one segment after another. As all segments composing one process unit are received, the determination result produced in the process carried out at the step S118 indicates that the process unit has been completed. That is to say, the value of variable ucb_nseg becomes equal to the value of variable ucb_cseg. In this case, the flow of the processing goes on to a step S120 at which the updating section 363 carries out a process to update variable scb_loss by adoption of the weighted average method at a loss rate of 0.

For example, the weighted average method at a loss rate of 0 is adopted as follows:

$$scb\_loss [ ucb\_sid [ i ] ] = scb\_loss [ ucb\_sid [ i ] ] \times ( 1 - α ) + 0.2 \times α \qquad ( 6 )$$

Then, at the next step S121, the determination section 361 determines whether or not the value of variable ucb_sample[n] is equal to 1. When the initial segment arrives as the first segment, as described above, this variable is set at 1 in the process carried out at the step S113. Thus, in this case, the value of variable ucb_sample[n] is equal to 1 so that the flow of the processing goes on to a step S122 at which the updating section 363 computes a band by using a period of time lapsing since a time stored in variable ucb_init and variable ucb_recv. Then, the updating section 363 carries out a process to update scb_bands by adoption of the weighted average method.

The computation of the band is explained as follows. A time at which the initial segment is received is stored in variable ucb_init in the process carried out at the step S115. Thus, by subtracting the time at which the initial segment is received from the present time, the period of time lapsing since the time stored in variable ucb_init can be found. On the other hand, the total amount of data received so far is stored in variable ucb_recv in the process carried out at the step S117. Thus, by dividing the value stored in variable ucb_recv as the total amount of data received so far by the lapsing period of time, the amount of received data per delay time unit can be found. That is to say, the band can be found. Then, the updating section 363 carries out a process to update variable scb_band representing a predicted band width of a bottleneck by adoption of the weighted average method.

Assume for example that the value stored in variable ucb_init[n] to represent the arrival time of the initial segment is 1203400 milliseconds, the value stored in variable ucb_recv[n] to represent the total number of bytes of received segments is 5670000 and the present time at which the process unit is completed is 1205400 milliseconds. In this case, the band is computed as follows.

$$\begin{matrix}Band = 5670000 / ( ( 1205400 - 1203400 ) / 1000 ) \\ = 2835000 bytes \text{/} second \times α\end{matrix} \qquad ( 7 )$$

In addition, the weighted average of the band is found as follows:

$$\begin{matrix}Weighted average = scb\_band [ s ] \\ = scb\_band [ s ] \times ( 1 - α ) + 2835000 \times α\end{matrix} \qquad ( 8 )$$

After the above processing is carried out, the flow of the processing goes on to a step S123. If the determination result produced in the process carried out at the step S121 indicates that the value of variable ucb_sample[n] is not equal to 1, that is, the initial segment has arrived not as the first segment, on the other hand, the flow of the processing also goes on to the step S123, skipping the process of the step S122.

At the step S123, the releasing section 365 releases a reserved area. To put it concretely, the value of variable gcb_rbuf representing the reserved advertised buffer size is subtracted from the value of variable ucb_rsvbuf representing the reserved buffer size. That is to say, since the entire process unit in the reserved area has been received, a corresponding reserved area is released.

Then, at the next step S124, the storage section 364 transfers the process unit from the temporary storage section 366 to the delay buffer 301. To put it concretely, the process unit stored in the temporary storage section 366 is read out and stored in the delay buffer 301. Then, the value of variable ucb_recv representing the amount of all received data is added cumulatively to the value of variable gcb_curbuf representing the present buffer size. That is to say, the value Cunt or Bcur shown in FIG. 11 is thereby updated.

If the determination result produced in the process carried out at the step Slll indicates hdr_type of the header is BUFLACK, the flowchart goes on to the step S125 at which the updating section 363 carries out a process to update information on buffer insufficiency. To put it concretely, variable scb_lack is incremented by 1. Variable scb_lack is the number of received segments of the BUFLACK type. The segments of the BUFLACK type have been detected among segments received from the server 41 so far.

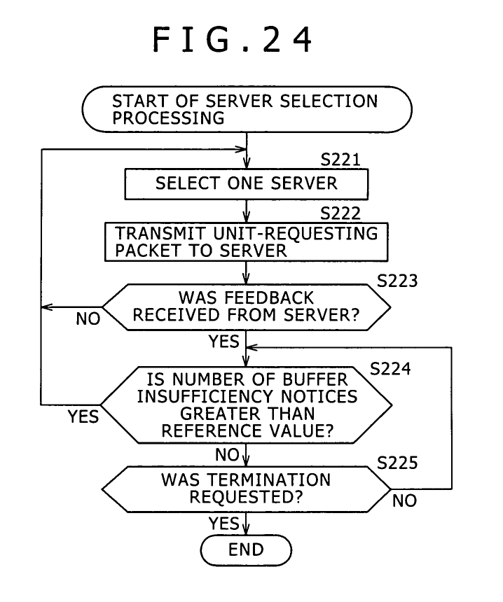

This value is used as a criterion reference for determining whether or not to change the server in a process carried out at a step S224 of a flowchart to be described later by referring to FIG. 24.

The processing described above is carried out in the client 42 every time a segment is received from the server 41. The client 42 manages all process units and segments transmitted by the server 41 at requests made by the client 42. Thus, even when the client 42 moves to another location, the client 42 is capable of receiving a continuation of a process unit in a streaming transmission from a server other than the server 41 transmitting the process unit so far.

As described above, the client 42 executes the management so as to store typically a maximum of 10 process units in the delay buffer 301. As data of a predetermined amount is stored in the delay buffer 301, the client 42 carries out sequential reproduction processing in a real-time manner. For this real-time reproduction processing, the client 42 is provided with a functional configuration like one shown in FIG. 22. In actuality, this functional configuration is also integrated with the configurations shown in FIGS. 14 and 20.

In the typical functional configuration shown in FIG. 22, the client 42 has a determination section 371, a reproduction section 372 and a termination section 373.

The determination section 371 is a section for carrying out a process to determine a rate of occupation of the delay buffer 301, a process to determine whether or not the delay buffer 301 has run out of data and a process to determine whether or not a command to end reproduction processing has been received. The reproduction section 372 is a section for carrying out a process to reproduce content data stored in the delay buffer 301 in a controlled manner. The termination section 373 is a section for carrying out a process to end reproduction processing.

It is to be noted that, in actuality, the delay buffer 301 can be used for storing only parameters required in management of the storage state. The data of a content itself can be stored in another area of the RAM 223. In order to make the explanation simple, however, the data of a content is also stored in the delay buffer 301. Examples of the parameters required in management of the storage state are Bmax, Cunt (Bcur), Brsv and Badv.

Next, processing carried out by the client 42 to reproduce a process unit is explained by referring to a flowchart shown in FIG. 23.

As shown in the figure, the flowchart begins with a step S151 at which the determination section 371 determines whether or not the occupation rate of the delay buffer 301 has reached 50%. The occupation rate is defined as a ratio of Bcur to Bmax (or Bcur/Bmax) where symbol Bcur denotes the amount of data presently stored in the delay buffer 301 and symbol Bmax denotes the maximum storage capacity of the delay buffer 301 as shown in FIG. 11.

If the determination result produced in the process carried out at the step S151 indicates that the occupation rate of the delay buffer 301 has not reached 50%, the flow of the processing goes on to a step S156 at which the determination section 371 determines whether or not a command to end reproduction processing has been received. If a command to end reproduction processing has not been received, the flow of the processing goes back to the step S151 to repeat the process of the step and carry out processes of subsequent steps.

If the determination result produced in the process carried out at the step S151 indicates that the occupation rate of the delay buffer 301 has reached 50%, on the other hand, the flow of the processing goes on to a step S152 at which the reproduction section 372 reproduces content data stored in the delay buffer 301 in process-unit granularities. Since a process unit is one GOP, if the data of one process unit exists, data of all frames composing the process unit can be decoded. Then, data reproduced/decoded by the reproduction section 372 is output to the output section 227 by way of the input/output interface 225 and displayed to the user as reproduced pictures.

Subsequently, at the next step S153, the determination section 371 determines whether or not the delay buffer 301 has run out of data. If the delay buffer 301 has not run out of data, the flow of the processing goes on to a step S154 at which the determination section 371 determines whether or not a command to end reproduction processing has been received. If a command to end reproduction processing has not been received, the flow of the processing goes back to the step S152 to repeat the processes of the steps S152, S153 and S154.

If the determination result produced in the process carried out at the step S153 indicates that the delay buffer 301 has run out of data, on the other hand, the flow of the processing goes on to a step S155 at which the termination section 373 ends the process to reproduce data.

Then, the flow of the processing goes on to a step S156 at which the determination section 371 determines whether or not a command to end reproduction processing has been received. If a command to end reproduction processing has not been received, the flow of the processing goes back to the step S151 to repeat the processes of the step and the subsequent steps. If the determination result produced in the process carried out at the step S156 or S154 indicates that a command to end reproduction processing has been received, on the other hand, the execution of the processing is ended.

As described above, at a request made by the client 42, the server 41 divides a file of a content into process units and further divides each of the process units into segments, which are then sequentially transmitted to the client 42. Before receiving all data of a file, the client 42 starts a reproduction process at a stage at which data having a predetermined amount is received. In this way, the streaming transmission can be realized in a real-time manner.

In the above embodiment of the present invention, the client 42 receives content data transmitted by the server 41 in a streaming transmission. As described above, the client 42 manages management data by itself as data required for receiving content data transmitted by the server 41 in a streaming transmission. Thus, even when the client moves to another location, the client 42 is capable of receiving a continuation of a process unit in a streaming transmission from a server other than the server 41 transmitting the process unit so far. Thus, the client 42 needs to select a server.

Next, processing carried out by the client 42 to qualify a server 41 is explained by referring to a flowchart shown in FIG. 24. This processing is carried out concurrently with pieces of processing represented by the flowcharts shown in FIGS. 16 and 21.

As shown in FIG. 24, the flowchart begins with a step S221 at which the setting section 333 of the client 42 selects one server. Assume for example that servers 41-1 to 41-3 exist in the typical information-processing system shown in FIG. 5. In this case, the setting section 333 selects one of the servers 41-1 to 41-3 as a server to transmit a desired content in a streaming transmission. As described earlier, in accordance with an embodiment of the present invention, each client holds information for selecting such a server in advance. The information held in advance by a client reveals which server has a content that may be desired by the user. If the TFR value expressed by Eq. (2) described earlier is already known for every server, the setting section 333 may select a server having the largest TFR value. As an alternative of dealing with such a plurality of servers 41, the client 42 transmits a prove packet to every server 41, measures an RTT from a response to the prove packet for every server 41 and selects a server 41 having a smallest RTT. Then, the client 42 transmits a packet used as a request for a process unit to the selected server 41.

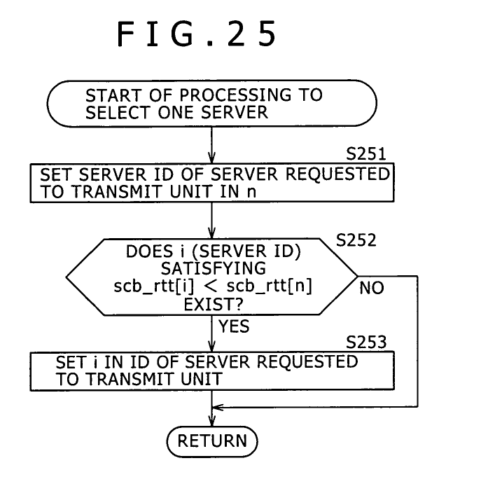

That is to say, if the RTT of every server 41 is already known, the client 42 is capable of selecting a server in processing represented by a flowchart shown in FIG. 25.

As shown in the figure, the flowchart begins with a step S251 at which the setting section 333 sets the server ID of the server 41 presently requested to transmit a process unit in a variable n. Then, at the next step S252, the determination section 332 determines whether or not a value i representing a server ID satisfying relation scb_rtt[i]<scb_rtt[n] exists. That is to say, the determination section 332 determines whether or not a server other than the server 41 presently requested to transmit a process unit exists as a server having an RTT smaller than that of the present server. If such another server exists, the flow of the processing goes on to a step S253 at which the setting section 333 uses the value i as the ID of a server to be requested to transmit a process unit. In this way, the server 41 presently requested to transmit a process unit is changed to another server having an RTT smaller than that of the present server. It is thus all but out of the bounds of possibility that the client 42 receives a segment having BUFLACK set in hdr_type of its header. That is to say, the client 42 is capable of receiving segments with a higher degree of reliability.

If the determination result produced in the process carried out at the step S252 indicates that another server having an RTT smaller than that of the server 41 presently requested to transmit a process unit does not exist, on the other hand, the processing of the step S253 is skipped.

After a server 41 is selected as described above, the client 42 returns to the processing represented by the flowchart shown in FIG. 24. At a step S222, the transmission section 337 transmits a packet used as a request for a process unit to the server 41 selected in the process carried out at the step S221. In actuality, the process to transmit a packet used as a request for a process unit to the server 41 is the transmission process carried out at the step S37 of the flowchart shown in FIG. 16.

Then, at the next sep S223, the determination section 332 determines whether or not a kind of feedback has been received from the server 41. If no feedback has been received from the server 41 even after a predetermined period of time has lapsed since the step S222 to transmit the packet used as a request for a process unit to the server 41, it is assumed that a failure has occurred in the server 41 or in the communication path due to some causes. Thus, if no feedback has been received from the server 41 even after a predetermined period of time has lapsed since the step S222 to transmit the packet used as a request for a process unit to the server 41, the flow of the processing goes back to the step S221 at which the setting section 333 selects another server. Then, at the next step S222, the transmission section 337 again transmits a packet used as a request for a process unit to the server 41 newly selected in the process carried out at the step S221. Subsequently, at the next sep S223, the determination section 332 again determines whether or not a kind of feedback has been received from the server 41.

In this way, a server providing some feedbacks is selected.

If a kind of feedback has been received from the server 41, the flow of the processing goes on to a step S224 at which the determination section 332 determines whether or not the number of buffer insufficiency notices is greater than a reference value. To put it concretely, the determination section 332 determines whether or not the value of variable scb_lack updated in the process carried out at the step S125 of the flowchart explained earlier by referring to FIG. 21 has exceeded a reference value. Variable scb_lack is the number of segments each received from the server 41 as a segment of the BUFLACK type. If the determination result produced in the process carried out at the step S224 indicates that variable scb_lack representing the number of buffer insufficiency notices has not exceeded the reference value, the flow of the processing goes on to a step S225 at which the determination section 332 determines whether or not an end command has been received from the user. If an end command has not been received from the user, the flow of the processing goes back to the step S224 to repeat the processes of the step and subsequent steps. If the determination result produced in the process carried out at the step S224 indicates that variable scb_lack representing the number of buffer insufficiency notices has exceeded the reference value, on the other hand, the flow of the processing goes back to the step S221 at which the setting section 333 again carries out the process to select another server. Then, the subsequent processes are repeated for the newly selected server in the same way.

If the determination result produced in the process carried out at the step S225 indicates that an end command has been received from the user, on the other hand, the execution of the processing to select a server is terminated.

The 3SP, which is a protocol proposed by the present invention, is positioned between transport and application layers in the hierarchical structure of the network protocol. This positioning of the 3SP is similar to that of the RTP (Real Time Protocol). As the transport layer, adoption of the UDP (User Datagram Protocol) is recommended, but the TCP can also be adopted. There are 4 main functions offered by the 3SP:
(1): Transmit a data retransmission request considering delay buffering. (For example, the process carried out at the step S32 of the flowchart shown in FIG. 16).
(2): Estimate a data transfer allowable capacity considering TCP friendliness. (For example, the process carried out at the step S34 of the flowchart shown in FIG. 16 to use a value computed by using Eq. (2) as an advertised buffer size).
(3): Transmit a packet used as a request for a process unit on the basis of a communication quality. (For example, the process carried out at the step S253 of the flowchart shown in FIG. 25).
(4): Transmit data based on a transfer allowable capacity specified by a receiver. (For example, the process carried out at the step S84 of the flowchart shown in FIG. 18).

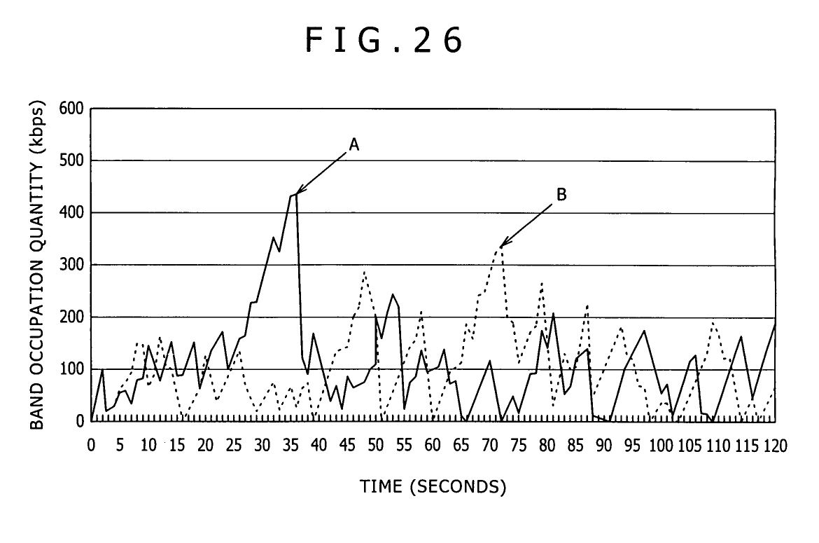

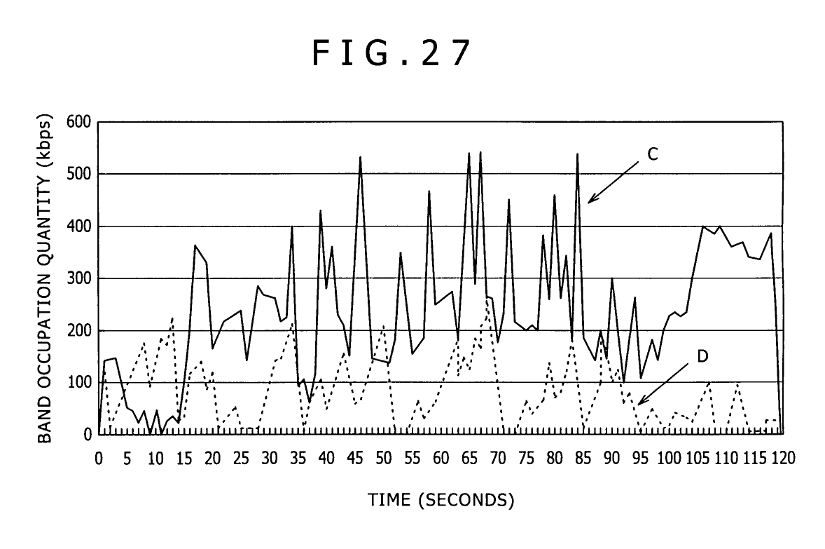

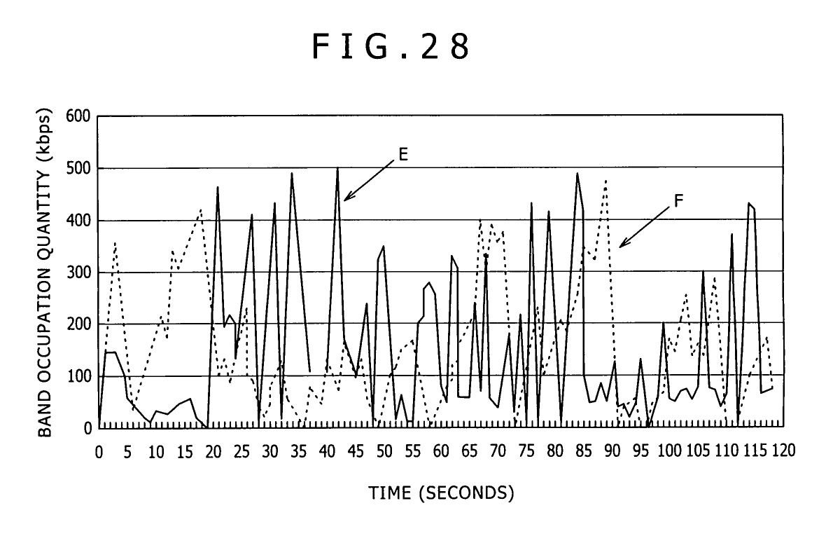

Next, results of simulations are explained. In the simulations, inventors of the present invention used the first 2-minute portion of an MPEG-4 trace file disclosed by Frank H. P. Fitzek et al. as traffic data of the simulations. The MPEG-4 trace file has a title of ‘MPEG-4 and H. 263 Video Traces for Network Performance Evaluation’ and can be accessed at http://www-tkn.ee.tuberlin.de/research/trace/simulation.html. Pieces of data encoded in a server for bit rates of 16 kbps, 64 kbps and 256 kbps were each divided into process units and held in the server. Three simulations were carried out for a case in which 20 flows shared a link of 2 Mbps and 10 ms. One of the simulations was carried out for 20 TCP flows to give a simulation result shown in FIG. 26. Another one of the simulations was carried out for 19 TCP flows and one 3SP flow having no congestion control function to give a simulation result shown in FIG. 27. A further one of the simulations was carried out for 19 TCP flows and one 3SP flow having a congestion control function to give a simulation result shown in FIG. 28.

The simulation results shown in FIGS. 26 to 28 for every flow each represent a band occupation quantity computed for every second on the time axis.

In these figures, naturally, a characteristic curve should be shown for each of 20 flows. If a characteristic curve is shown for each of 20 flows, however, the figure will become complicated. For this reason, only two characteristic curves are shown for two representative flows respectively.

As shown by characteristic curves A and B for 2 TCP flows in FIG. 26, the band is most occupied at a time of about 34 seconds for the curve A and a time of about 72 seconds for the curve B. It is thus obvious from the simulation result that, if observed over a long period of time, the TCP is a TCP for which flows occupy the band on an equality basis. If observed over a short period of time, however, the TCP is not a TCP based on equality.

In the result of the simulation shown in FIG. 27, on the other hand, a curve C for the 3SP flow with no congestion control executed occupies the band more than a curve D for a TCP flow. This is because, with the 3SP represented by the curve C, highest-quality data encoded for 256 kbps is always received on the basis of the capacity of the delay buffer 301 employed in the client 42 in spite of the fact that the link is an equal band of 100 kbps per flow (=2 Mbps/20 flows). It is to be noted that the execution of no congestion control implies that the TFR is not computed by using Eq. (2) but, instead, only the value found in accordance with Eq. (1) as an allowable value of the capacity of the delay buffer 301 is stored in a packet used as a request for a process unit.

As described above, a flow of transmission excluding the mechanism of the congestion control, hence, ignoring existence of other flows runs a risk of occupying large portions of the band.

In FIG. 28, a curve E represents a simulation result for the 3SP flow with congestion control executed and a curve F represents a simulation result for a TCP flow. As is obvious from the figure, the curve E shows that the 3SP flow with congestion control executed occupies the band excessively only on a temporary basis but, in the long term, clearly utilizes the band only a little bit in comparison with the curve C shown in FIG. 27 whereas the curve F shows that the TCP flow is also capable of sufficiently occupying the band.

As described above, the present invention proposes a communication system in which a server transmitting continuous media to a client does not have to hold by all means the state of communication with the client. The continuous media is delimited into data bunches each referred to as a process unit and transmitted to the client in process-unit granularities. By properly scheduling timings to acquire process units from the server, the client is capable of reconstructing the process units back into the continuous media. In addition, by including information on congestion in a packet used as a request for a process unit, the client is capable of allowing the server to optimize the bit rate of a content in process-unit granularities. Unlike a model of the conventional information-processing system in which the server plays the active role of distributing continuous media to clients in a push implementation, in the model according to an embodiment of the present invention, the client holds all information on connections with servers so that the client is capable of changing the server, from which process units are received, from one server to another in accordance with the condition of the client.

It is to be noted that the series of processes described above can be carried out by hardware and/or execution of software. If the series of processes described above is carried out by execution of software, programs composing the software can be installed into a computer embedded in dedicated hardware, a general-purpose personal computer or the like from typically a network or a program-recording medium. By installing a variety of programs into the general-purpose personal computer, the personal computer is capable of carrying out a variety of functions.

The aforementioned program-recording medium for recording the programs to be installed into a computer or a general-purpose personal computer as programs to be executed by the computer or the general-purpose personal computer respectively is the removable recording mediums 131 and 231 provided to the user separately from the main unit of the information-processing apparatus as shown in FIGS. 6 and 10 respectively. Examples of the removable recording mediums 131 and 231 include a magnetic disk such as a flexible disk, an optical disk such as a CD-ROM (Compact Disc-Read Only Memory) or a DVD (Digital Versatile Disk), a magneto-optical disk such as an MD (Mini Disk) as well as a semiconductor memory. Instead of installing the programs from the removable recording mediums 131 and 231, the programs can also be stored in advance in a recording medium embedded in the main unit of the information-processing apparatus. Examples of the embedded recording medium are hard disks included in the storage units 128 and the 228 and the ROMs (Read Only Memories) 122 and 222 shown in FIGS. 6 and 10 respectively.

It is also worth noting that, in this specification, steps of every program stored in a recording medium can be carried out not only in a pre-prescribed order along the time axis, but also concurrently or individually.

In addition, the technical term ‘system’ used in this specification implies the configuration of a confluence comprising a plurality of apparatus.

The present invention can be applied to an information-processing system for transmitting a content to a personal computer in a streaming transmission by way of the Internet.

It should be understood by those skilled in the art that a variety of modifications, combinations, sub-combinations and alterations may occur in dependence on design requirements and other factors insofar as they are within the scope of the appended claims or the equivalents thereof.

1. An information-processing system for providing information from a first information-processing apparatus to a second information-processing apparatus by way of a network, wherein:
the first information-processing apparatus comprises:
a reception section for receiving a request from the second information-processing apparatus as a request for information to be provided by the first information-processing apparatus; and
a transmission section for transmitting a file of the information to be provided by the first information-processing apparatus in processing units each decodable independently of the others of the processing units to the second information-processing apparatus; and
the second information-processing apparatus comprises:
an information-holding section for holding the information transmitted by the first information-processing apparatus;
an information-requesting section for managing the information held by the information-holding section and, in dependence of the amount of the information held by the information-holding section, issuing a request to the first information-processing apparatus as a request for transmission of the following information composing one of the processing units; and
a reproduction section for reproducing the information in aforementioned processing units when the amount of the information held by the information-holding section becomes greater than a reference value set in advance before all the processing units of the file are received.

2. An information-processing system according to claim 1,
wherein the transmission section divides each of the processing units into transmission units, in which each of the processing units is transmitted from the first information-processing apparatus to the second information-processing apparatus; and
wherein the second information-processing apparatus further comprises a temporary storage section for temporarily storing information transmitted by the first information-processing apparatus in transmission units and, when the number of transmission units stored in the temporary storage section reaches the number of transmission units composing a processing unit, the transmission units stored in the temporary storage section may be transferred to the information-holding unit to be held therein.

3. An information-processing system according to claim 2, the processing unit and the transmission unit are handled as a process unit and a segment respectively.

4. An information-processing system according to claim 3, the segment is set to have such a size that the segment can be accommodated in a packet used as a unit of transmission by way of the network.

5. An information-processing method adopted by an information-processing system for providing information from a first information-processing apparatus to a second information-processing apparatus by way of a network, the information-processing method comprising a first information-processing method adopted by the first information-processing apparatus and a second information-processing method adopted by the second information-processing apparatus;
the first information-processing method comprising the steps of:
receiving a request from the second information-processing apparatus as a request for information to be provided by the first information-processing apparatus; and
transmitting a file of the information to be provided by the first information-processing apparatus in processing units each decodable independently of the others of the processing units to the second information-processing apparatus;
the second information-processing method comprising the steps of:
holding the information transmitted by the first information-processing apparatus;
managing the information held in processing carried out at the information-holding step and, in dependence of the amount of the information held in processing carried out at the information-holding step, issuing a request to the first information-processing apparatus as a request for transmission of the following information composing one of the processing units; and
reproducing the information in aforementioned processing units when the amount of the information held in processing carried out at the information-holding step becomes greater than a reference value set in advance before all the processing units of the file are received.

6. An information-processing apparatus for receiving a request for information from an other information-processing apparatus by way of a network and transmitting the requested information to the other information-processing apparatus in accordance with the request by way of the network, the information-processing apparatus comprising:
a reception section for receiving a request from the other information-processing apparatus as a request for each of processing units each decodable independently of the others of the processing units to be transmitted to the other information-processing apparatus as one of the processing units composing a file of the requested information;
a transmission section for dividing each of the processing units into transmission units and transmitting the information in aforementioned transmission units to the other information-processing apparatus; and
a determination section for:
determining whether or not transmission of all the transmission units composing a specific one of the processing units has been completed;
terminating transmission of the specific processing unit if a determination result indicates that the transmission of all the transmission units composing the specific processing unit has been completed; and
requesting the transmission section to transmit a next one of the processing units in aforementioned transmission units if the reception section receives a request for the next processing unit.

7. An information-processing apparatus according to claim 6, the processing unit and the transmission unit are handled as a process unit and a segment respectively.

8. An information-processing apparatus according to claim 7, the segment is set to have such a size that the segment can be accommodated in a packet used as a unit of transmission by way of the network.

9. An information-processing apparatus according to claim 7, the transmission section transmits an empty segment virtually containing no information with a timing coinciding with the beginning of each of the processing units.

10. An information-processing method adopted by an information-processing apparatus for receiving a request for information from an other information-processing apparatus by way of a network and transmitting the requested information to the other information-processing apparatus in accordance with the request by way of the network, the information-processing method comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
determining whether or not transmission of all the transmission units composing a specific one of the processing units has been completed;
terminating transmission of the specific processing unit if a determination result indicates that the transmission of all the transmission units composing the specific processing unit has been completed; and
requesting to transmit a next one of the processing units in aforementioned transmission units in processing carried out at the above unit-dividing and unit-transmitting step if a request for the next processing unit is received in processing carried out at the above request-receiving step.

11. A recording medium for storing a computer program of an information-processing apparatus for receiving a request for information from an other information-processing apparatus by way of a network and transmitting the information to the other information-processing apparatus in accordance with the request by way of the network, the computer program comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
determining whether or not transmission of all the transmission units composing a specific one of the processing units has been completed;
terminating transmission of the specific processing unit if a determination result indicates that the transmission of all the transmission units composing the specific processing unit has been completed; and
requesting to transmit a next one of the processing units in aforementioned transmission units in processing carried out at the above unit-dividing and unit-transmitting step if a request for the next processing unit is received in processing carried out at the above request-receiving step.

12. A computer program of an information-processing apparatus for receiving a request for information from an other information-processing apparatus by way of a network and transmitting the information to the other information-processing apparatus in accordance with the request by way of the network, the computer program comprising the steps of:
receiving a request from the other information-processing apparatus as a request for each of processing units each decodable independently of the others of the processing units to be transmitted to the other information-processing apparatus as one of the processing units composing a file of the requested information;
dividing each of the processing units into transmission units and transmitting the information in aforementioned transmission units to the other information-processing apparatus; and
executing the sub-steps of:
determining whether or not transmission of all the transmission units composing a specific one of the processing units has been completed;
terminating transmission of the specific processing unit if a determination result indicates that the transmission of all the transmission units composing the specific processing unit has been completed; and
requesting to transmit a next one of the processing units in aforementioned transmission units in processing carried out at the above unit-dividing and unit-transmitting step if a request for the next processing unit is received in processing carried out at the above request-receiving step.

13. An information-processing apparatus for requesting an other information-processing apparatus to provide information to the information-processing apparatus by way of a network and receiving the information from the other information-processing apparatus, the information-processing apparatus comprising:
an information-holding section for holding the requested information transmitted by the other information-processing apparatus by dividing a file of the information into processing units each decodable independently of the others of the processing units, further dividing each of the processing units into transmission units and transmitting each of the transmission units by way of the network;
a determination section for determining the amount of information held by the information-holding section as one of the processing units;
a unit-requesting section for requesting the other information-processing apparatus to provide a next one of the processing units to the information-processing apparatus on the basis of a determination result produced by the determination section;
a request management section for managing requests issued to the other information-processing apparatus; and
a reproduction section for reproducing the information in aforementioned processing units when the amount of the information held by the information-holding section becomes greater than a reference value set in advance before all the processing units of the file are received.

14. An information-processing apparatus according to claim 13, the management section is capable of managing information identifying other information-processing apparatus, times at which the other information-processing apparatus is requested to transmit any one of the processing units and planned amounts of information to be held in the information-holding section.

15. An information-processing apparatus according to claim 14, the unit-requesting section notifies the other information-processing apparatus of a planned amount of information to be held in the information-holding section and the information-processing apparatus further comprises an updating section for updating a reserved magnitude of an amount of information to be held in the information-holding section on the basis of the planned amount of information reported to the other information-processing apparatus.

16. An information-processing apparatus according to claim 13, the processing unit and the transmission unit are handled as a process unit and a segment respectively.

17. An information-processing apparatus according to claim 16, the segment is set to have such a size that the segment can be accommodated in a packet used as a unit of transmission by way of the network.

18. An information-processing apparatus according to claim 13, the information-processing apparatus further comprises a period-processing section for computing a period of time between issuance of a request for a processing unit to the other information-processing apparatus and reception of the requested processing unit when an empty segment virtually containing no information is received with a timing coinciding with the beginning of each of the processing units.

19. An information-processing apparatus according to claim 13, the information-processing apparatus further comprises:
a temporary storage section for temporarily storing transmission units transmitted by the other information-processing apparatus till all transmission units of one processing unit are received from the other information-processing apparatus; and
a transfer unit section for transferring the transmission units stored in the temporary storage section to the information-holding section to be held therein as all transmission units of one processing unit are stored in the temporary storage section.

20. An information-processing method adopted in an information-processing apparatus for requesting an other information-processing apparatus to provide information to the information-processing apparatus by way of a network and receiving the information from the other information-processing apparatus, the information-processing method comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.

21. A recording medium for storing a computer program of an information-processing apparatus for requesting an other information-processing apparatus to provide information to the information-processing apparatus by way of a network and receiving the information from the other information-processing apparatus, the computer program comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.

22. A computer program of an information-processing apparatus for requesting an other information-processing apparatus to provide information to the information-processing apparatus by way of a network and receiving the information from the other information-processing apparatus, the computer program comprising the steps of:
holding the requested information transmitted by the other information-processing apparatus by dividing a file of the information into processing units each decodable independently of the others of the processing units, further dividing each of the processing units into transmission units and transmitting each of the transmission units by way of the network;
determining the amount of information held in processing carried out at the information-holding step as one of the processing units;
requesting the other information-processing apparatus to provide a next one of the processing units to the information-processing apparatus on the basis of a determination result produced in processing carried out at the determination step;
managing requests issued to the other information-processing apparatus; and
reproducing the information in aforementioned processing units when the amount of the information held in processing carried out at the information-holding step becomes greater than a reference value set in advance before all the processing units of the file are received.
